(19) United States
(12) Patent Application Publication
(10) Pub. No.: US 2014/0007395 A1
(43) Pub. Date: Jan. 9, 2014

(54) CLAMP FORMING APPARATUS AND METHOD

(71) Applicants: Todd Hemingway, Metamora, MI (US); Walter Pipp, Birmingham, MI (US); Michael Richard Danby, Stoney Creek (CA); Dorian Kilgore, Rochester Hills, MI (US); Todd Murray, Gaines, MI (US)

(72) Inventors: Todd Hemingway, Metamora, MI (US); Walter Pipp, Birmingham, MI (US); Michael Richard Danby, Stoney Creek (CA); Dorian Kilgore, Rochester Hills, MI (US); Todd Murray, Gaines, MI (US)

(73) Assignee: A. Raymond et Cie, Grenoble (FR)

(21) Appl. No.: 13/991,357

(22) PCT Filed: Feb. 3, 2012
(86) PCT No.: PCT/US12/23808

§ 371 Date: Aug. 30, 2013

Related U.S. Application Data
(60) Provisional application No. 61/439,158, filed on Feb. 3, 2011.
(60) Provisional application No. 61/439,125, filed on Feb. 3, 2011.

(51) Int. Cl. B23P 15/00

(52) U.S. Cl. CPC B23P 15/00
USPC 29/281.1

(57) ABSTRACT

A clamp forming apparatus capable of forming a clamp is shown and described. The clamp formed may have first and second engaging portions. The clamp forming apparatus may include at least one securing member. The clamp forming apparatus may also include a clamp positioning device operatively engaged with the at least one securing member, where at least one of the first or second engaging portions is supported by the clamp positioning device, and where a tangential load is applied around a circumference of the clamp and the at least one securing member secures at least one of the engaging portions of the clamp together in a direction generally normal to the tangential load.

### CROSS-REFERENCE TO RELATED APPLICATION

This application is the National Stage of International Application No. PCT/US2012/023808, filed Feb. 3, 2012, which claims benefit from U.S. Provisional Patent Application No. 61/439,125, entitled “Automatic Clamp Forming Apparatus,” filed on Feb. 3, 2011, and U.S. Provisional Patent Application No. 61/439,158, entitled “Manual Clamp Forming Apparatus,” filed on Feb. 3, 2011, all of which are hereby incorporated in their entirety by reference.

### FIELD OF THE INVENTION

The present invention generally relates to an apparatus and method for forming a clamp and, more specifically, to an apparatus for forming a clamp and a method for forming a clamp.

### BACKGROUND

Clamping devices, such as ring clamps, have been used for any variety of purposes. By way of a non-limiting example, clamps have been utilized to secure any appropriate number of types of components to a device. The devices to be secured may be of any appropriate shape, size, type or configuration. By way of a non-limiting example, the clamp may be utilized to secure an airbag to an inflating or injector tube device. The clamp may also be utilized on a variety of other devices, such as constant velocity joint boots, power steering pumps and hoses, HVAC hoses, hydraulic hoses, water lines, an axle having rubber boots that may engage a wheel hub where the boot may be held on with a clamp, radiator hoses, and the like.

Often, after being clamped or secured onto a device, clamps may encounter various forces and pressures that may resist the clamping force or prevent the clamp from remaining secure on the device. To resist these forces, clamping devices of considerable strength must be provided to maintain the clamp on the device. In a non-limiting example, ring clamps may often be used to secure an airbag component to an inflating tube device. These ring clamps may be positioned around the inflating tube device and the airbag to clamp the airbag to the inflating tube.

These ring clamps, however, may be problematic for a number of reasons. First, during inflation of the airbag, typical ring clamps may tend to slip off of the inflating tube device. Some clamps may have attempted to cure this problem by attaching a hook-like device to the inflating tube to prevent the ring clamp from sliding off of the inflating tube device. This solution, however, may be costly and may only act as a preventive measure rather than curing the original deficiencies of the clamps.

In many applications, these ring clamps may be locked in a closed position by crimping, piercing or otherwise locking the ring clamp. The crimping or locking, however, occurs in the same direction of the load path. In other words, the ring clamp is locked in the same direction as the applied force, which may typically be a direction parallel to the clamp's circumference. As a result, the residual clamp load of these clamps is diminished in view of the initial compression load applied to the ring clamps.

Typical ring clamps may be unreliable in maintaining the connection of the component to the device. This may be particularly true in the situation of an air bag, especially if the occupant contacts the airbag with a high amount of force.

As a result of the relatively low residual clamp load, manufacturers of these clamps may be forced to use expensive metal materials, such as high grade stainless steel. Mild steels, which typically may cost less, have been thought to be incapable of adequately resisting the forces caused by the nearly instantaneous inflation of the airbag. Therefore, these typical ring clamps may have been relatively costly to manufacture. Therefore, there is a need for a clamp and an apparatus to install such clamp that may overcome at least some of these shortcomings.

### SUMMARY OF INVENTION

A clamp forming apparatus capable of forming a clamp is shown and described. The clamp formed may have first and second engaging portions. The clamp forming apparatus may include at least one securing member. The clamp forming apparatus may also include a clamp positioning device operatively engaged with the at least one securing member, where at least one of the first or second engaging portions is supported by the clamp positioning device, and where a tangential load is applied around a circumference of the clamp and the at least one securing member secures at least one of the engaging portions of the clamp together in a direction generally normal to the tangential load.

A clamp forming apparatus for forming a clamp having first and second engaging portions is shown. The clamp forming apparatus may include a mount removably securing one of the first or second engaging portions generally in place and a clamp positioning device, where at least one of the first or second engaging portions is supported by the clamp positioning device. The clamp forming apparatus may also include a securing member operatively engaged with the clamp positioning device, where a tangential load is applied around a circumference of the clamp, and where the securing member secures at least one of the engaging portions of the clamp in a direction normal to the tangential load.

A clamp forming apparatus for forming a clamp having first and second engaging portions is shown and described. The clamp forming apparatus may include a clamp mounting device capable of securing at least one of the first and second portions of the clamp and a closure assembly adjacent the clamp mounting device. The clamp forming apparatus may also include an actuator operably coupled to the closure assembly, where the actuator engages the second portion of the clamp to position the second portion adjacent the first portion causing the clamp to apply a tangential load, and at least one piercing arm capable of piercing at least one of the first or second portions of the clamp in a direction generally perpendicular to the tangential load applied by the clamp.

A clamp forming apparatus for forming a clamp having first and second engaging portions around a device where the clamp forming apparatus may include a clamp securing member, where the first engaging portion is generally secured in place by the clamp securing member and a closure engageable with the second engaging portion, where the closure is capable of selectively positioning the second engaging portion toward the first engaging portion applying a tangential load around a circumference of the clamp. The clamp forming apparatus may also include at least one securing member, where the at least one securing member engages at least one of the first and second engaging portions in a direction normal to the tangential load securing the first and second engaging portions.

A clamp forming apparatus for forming a clamp around a device, the clamp forming apparatus may include a closure assembly operable to close the clamp via a tangential load applied around a circumference of the clamp to form the clamp around the device. The clamp forming apparatus may include a clamp positioning insert securing the clamp to be formed, wherein the clamp positioning insert is operatively engaged with a load cell.

A clamp forming apparatus for forming a clamp around a device, the clamp forming apparatus may include a securing assembly having a shaft operable by an actuator and a guide rod operatively engaged with the shaft. The clamp forming apparatus may also include at least one securing member operatively engaged with the guide rod, such that axial positioning of the guide road operatively positions the at least one securing member to engage the clamp in a direction normal to a circumference of the clamp, and a load cell operatively coupled with the at least one securing member.

A method for forming a clamp having first and second engaging portions around a device is shown and described. The method may include the steps of positioning the clamp within a clamp positioning member; and applying a tangential load around a circumference of the clamp, where the clamp closes around the device. The method may also include the steps of actuating at least one securing member, and engaging at least one of the engaging portions of the clamp by actuating the at least one securing member in a direction normal to the tangential load.

A clamp forming apparatus may include a clamp positioning device capable of securing at least a first portion of a clamp and a closure device capable of engaging at least a second portion of the clamp. The clamp forming apparatus may also include an actuator operably coupled to the closure device to engage the second portion of the clamp to apply a tangential load around a circumference of the clamp, and at least one engaging member capable of piercing at least one of the first or second portions of the clamp in a direction normal to the tangential load.

### BRIEF DESCRIPTION OF THE DRAWINGS

The operation of the invention may be better understood by reference to the following detailed description taken in connection with the following illustrations, wherein:

FIG. 1 is a perspective view of a clamp in an open position.

FIG. 2 is a front view of the clamp of FIG. 1.

FIG. 3 is an elevation view of the clamp of FIG. 1.

FIG. 4 is a plan view of the clamp of FIG. 1.

FIG. 5 is a front view of the clamp of FIG. 1 secured in a closed position.

FIG. 6 is a cross-sectional side view of the clamp of FIG. 5.

FIG. 7 is a perspective view of embodiments of a clamp in a partially open position.

FIG. 8 is a perspective view of the clamp of FIG. 7.

FIG. 9 is a front view of the clamp of FIG. 7.

FIG. 10 is a perspective view of embodiments of a manual clamp forming apparatus.

FIG. 11 is a partially exploded perspective view of the manual clamp forming apparatus of FIG. 10.

FIG. 12 is a side view of the manual clamp forming apparatus of FIG. 10 before the closure operation.

FIG. 13 is a side view of the manual clamp forming apparatus of FIG. 10 during the closure operation.

FIG. 14 is a plan view of the manual clamp forming apparatus of FIG. 10.

FIG. 15 is a cross-sectional perspective side view of the manual clamp forming apparatus of FIG. 12 taken along line 14-14.

FIG. 16 is a cross-sectional plan view of the manual clamp forming apparatus of FIG. 14 along line 15-15.

FIG. 17 is a cross-sectional plan view of the manual clamp forming apparatus of FIG. 14 showing a view of a clamp positioning insert during a piercing operation.

FIG. 18 is a detail view of the clamp positioning insert of FIG. 17 during a piercing operation.

FIG. 19 is a cross-sectional perspective view of the manual clamp forming apparatus of FIG. 16.

FIG. 20 is a perspective of a clamp positioning insert of FIG. 11.

FIG. 21 is a perspective view of embodiments of an automatic clamp forming apparatus.

FIG. 22 is a cross-sectional perspective view of the automatic clamp forming apparatus of FIG. 21.

FIG. 23 is a plan view of the automatic clamp forming apparatus of FIG. 21.

FIG. 24 is an elevation view of the automatic clamp forming apparatus of FIG. 21.

FIG. 25 is a top cross-sectional view of the automatic clamp forming apparatus taken along lines 24-24 of FIG. 24 prior to a piercing operation.

FIG. 26 is a top cross-sectional view of the automatic clamp forming apparatus taken along lines 24-24 of FIG. 24 during a piercing operation.

FIG. 27 is a detail view of the automatic clamp forming apparatus of FIG. 25 prior to the piercing operation.

FIG. 28 is a detail view of the automatic clamp forming apparatus of FIG. 26 during the piercing operation.

FIG. 29 is a perspective view of a clamp positioning insert of the automatic clamp forming apparatus of FIG. 21.

FIG. 30 is a plan view of additional embodiments of an automatic clamp forming apparatus during a piercing operation.

FIG. 31 is a detail view of the automatic clamp forming apparatus of FIG. 30 prior to a piercing operation.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

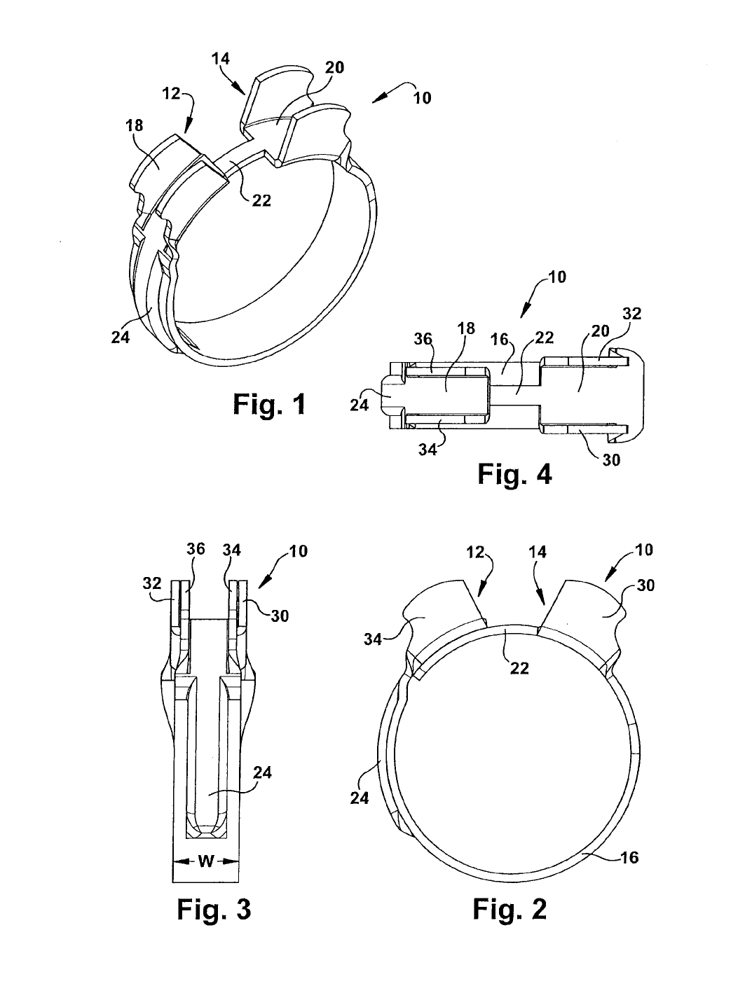

A clamp 10 made in accordance a clamp forming apparatus, exemplary embodiments of which are shown as a manual clamp forming apparatus 60 and/or an automatic clamp forming apparatus 260, is shown in FIGS. 1-9. The clamp 10 may be of any appropriate shape, size, type or configuration, such as substantially circular, oval, elliptical or the like. The clamp 10 may be fabricated out of any appropriate material and may be fabricated by any appropriate method or process, including, without limitation by utilizing the clamp forming apparatuses 60 and 260. The clamp 10 may be fabricated out of many different combinations or types of materials. By way of a non-limiting example, the clamp 10 may be fabricated out of metal, such as stainless steel or low carbon steel.

In some embodiments, the clamp 10 material may be pre-galvanized with a zinc based material, such that it may possess a zinc finish. In these embodiments, the zinc may act as an anode, whereby the clamp 10 may generally not rust. The clamp 10 material may be a deep draw quality steel, whereby it may provide both pull and stretch during formation of the clamp 10. The steel may provide for plastic deformation, such as an approximately 18% minimum plastic deformation. The clamp 10 may have the capability of forming to a variety of different ranges. In a non-limiting example, the clamp 10 may have a total range of stretch of approximately 10 mm—this may result in a range of diameters being 1.8 mm—which may result a useable range of approximately +/−0.9 mm per clamp 10.

The clamp 10 material may also be easy to pierce; whereby it may be pierced by any appropriate means, such as by hydraulic and pneumatic piercing or the like. While the clamp 10 is shown as a single piece construction, it is to be understood that the clamp 10 could be formed out of any number of appropriate pieces and secured together by any appropriate means, such as by welding, adhesives, mechanical joints, or the like, by way of a non-limiting example.

The clamp 10 may be utilized for any appropriate purpose. By way of a non-limiting example, the clamp 10 may be utilized to secure any appropriate number of types of components to a device 58. The device 58 may be of any appropriate shape, size, type or configuration. By way of a non-limiting example, the clamp 10 may be utilized to secure an airbag (not shown) to an inflating or injector tube device 58. The clamp 10 may also be utilized on a variety of other devices 58, such as constant velocity joint boots, power steering pumps and hoses, HVAC hoses, hydraulic hoses, water lines, an axle having rubber boots that may engage a wheel hub where the boot may be held on with a clamp 10, and the like.

The clamp 10 may be used with materials that may be more elastic than materials that may have been previously used with prior art clamps. The increased elasticity (or flexibility) of the material of the clamp 10 may improve its ability to effectively clamp onto devices 58.

The clamp 10 may include a first end 12 and a second end 14. The clamp 10 may have a length or circumference in circular embodiments that may be defined between the first end 12 and the second end 14. The clamp 10 may further include a coating (not shown). The coating may cover any appropriate portion or amount of the clamp 10. The coating may substantially cover the entire clamp 10. The coating may also be of any appropriate color, such as similar color to the material of the clamp 10, a color that is part of a color coding system, or a color distinct from the material of the clamp 10, by way of non-limiting examples.

In a non-limiting example, the clamp 10 may utilize a coating having a color that may be different from the clamp 10 material, whereby any undesired manipulation or unauthorized servicing of the clamp 10 may cause scratching, flaking or otherwise removing the coating from the clamp 10. This undesired manipulation or unauthorized servicing of the clamp 10 may, therefore, be readily apparent.

The coating of the clamp 10 may be of any appropriate type of coating. In some embodiments, the coating may be an organic coating having a color distinct from the device 58 and the clamp 10. The coating may be able to stretch with the clamp 10. In these embodiments, as the first end 12 and/or the second end 14 is stretched and moved to close and secure the clamp 10 around a device, the coating may remain consistent around the clamp 10.

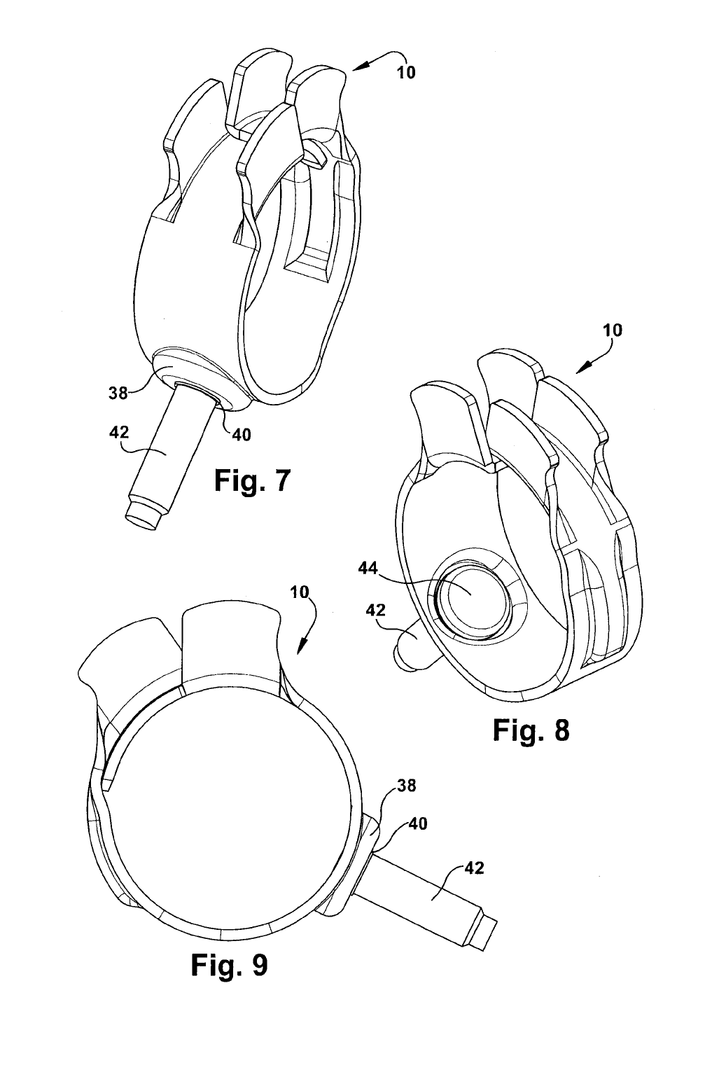

The clamp 10 may have a width W; see FIGS. 3 and 6. The width W may be of any appropriate size or dimension. The width W may be determined based on any appropriate means, such as by the strength and size of the device with which the clamp 10 may be used. In addition, the width W may be a function of the required clamping strength to be imparted with the clamp 10. The width W of the clamp 10 may be tuned to change the residual load of the clamp 10 as a function of the compression load of the clamp 10. Generally, increasing the width W of the clamp 10 may increase the residual clamp load as a function of the compression load. For a predetermined compression load, the greater the width W of the clamp 10 the higher the residual load.

The residual clamp load and the compression load may be determined or limited by the device 58 with which the clamp 10 may be used. In a non-limiting example, if the clamp 10 is to be used to clamp an airbag to an inflating tube device 58, then the inherent strength of the inflating tube device 58 may limit the compression load and/or residual clamp load that may be applied by the clamp 10 without damaging the inflating tube device 58. Therefore, an analysis of the device 58 with which the clamp 10 will be used may be necessary before tuning the width W of the clamp 10.

The clamp 10 may include an annular ring portion 16, a first engaging portion 18 and a second engaging portion 20; see FIGS. 1 and 4. The annular ring portion 16 may include a guide 22 and a boss 24; see FIGS. 1 and 2. The annular ring portion 16 may be of any appropriate shape, size, type or configuration. The annular ring portion 16 may have any appropriate size and shape diameter, such as a diameter substantially similar in size and shape to the device 58 in which the clamp 10 is to be attached. The annular ring portion 16 may terminate near the first end 12 and the second end 14.

The guide 22 may be of any appropriate shape, size, type or configuration, such as of a generally curved rectangular configuration; see FIGS. 1 and 2. The guide 22 may be located at any appropriate position on the clamp 10, such as located on the first end 12 or the second end 14; see FIGS. 1, 2 and 4. In some embodiments, the guide 22 may be located at and extend from the second end 14 towards and past the first end 12, whereby the guide 22 may form a continuous 360 degree surface for the clamp 10, or the like. The guide 22 may direct the second end 14 of the clamp 10 towards the first end 12 of the clamp 10 at a desired position.

The boss 24 may be of any appropriate shape, size, type or configuration, such as of a generally curved rectangular configuration as shown in FIGS. 1-5. The boss 24 may be located at any appropriate position on the clamp 10, such as located along a side of the annular ring portion 16 adjacent the first end 12; see FIGS. 1, 2 and 4. In some embodiments, the boss 24 may accept and abut the guide 22 during and after formation of the clamp 10, whereby the guide 22 may slide within the boss 24.

In some embodiments, the structure of the clamp 10 may permit a relatively large amount of travel or movement before being secured in the closed position. Accordingly, the clamp 10 may be readily connectable to a device 58, such as an inflating tube of an airbag system before closing the clamp 10.

The first engaging portion 18 and the second engaging portion 20 may be of any appropriate shape, size, type or configuration, such as of a general U-shape configuration shown in FIGS. 1 and 4. The first engaging portion 18 and the second engaging portion 20 may be of a similar shape or size or of different shapes or sizes. The first engaging portion 18 and the second engaging portion 20 may be located at any appropriate position on the clamp 10. In some embodiments, the first engaging portion 18 may be located at the first end 12 and the second engaging portion 20 may be located at the second end 14; see FIG. 1.

The first engaging portion 18 and the second engaging portion 20 may be of a substantially similar shape and size so that one of the first or second engaging portions 18, 20 may be able to fit and slide within the other engaging portion 18, 20. In some embodiments, the first engaging portion 18 may be slightly wider or larger than the second engaging portion 20, whereby the second engaging portion 20 may slide within the first engaging portion 18. While shown with the first engaging 18 portion being slightly larger than the second engaging portion 20, it is to be understood that the roles may be reversed so that the second engaging portion 20 may be larger than the first engaging portion 18.

The first engaging portion 18 and the second engaging portion 20 may be capable of securing the clamp 10 in a compressed state or closed position. The first and second engaging portions 18, 20 may be extended portions of the annular ring portion 16, whereby the first and second engaging portions 18, 20 may be bent to a direction generally perpendicular to the circumference of the clamp 10. Alternatively, the first and second engaging portions 18, 20 may be molded or otherwise formed at a position substantially perpendicular to the circumference of the clamp 10.

The first engaging portion 18 may include a first inner plate 34 and a second inner plate 36. The plates 34, 36 may be of any appropriate shape, size, type or configuration, such as of a generally square, semi-circular or rectangular planar configuration as shown in FIG. 2. The plates 34, 36 may also be of a similar shape and size, but are not limited to such. The first inner plate 34 and the second inner plate 36 may be located at any appropriate position on the clamp 10, such as at the first end 12, whereby the plates 34, 36 may be facing one another; see FIGS. 3 and 4. In some embodiments, the first inner plate 34 may be opposing the second inner plate 36.

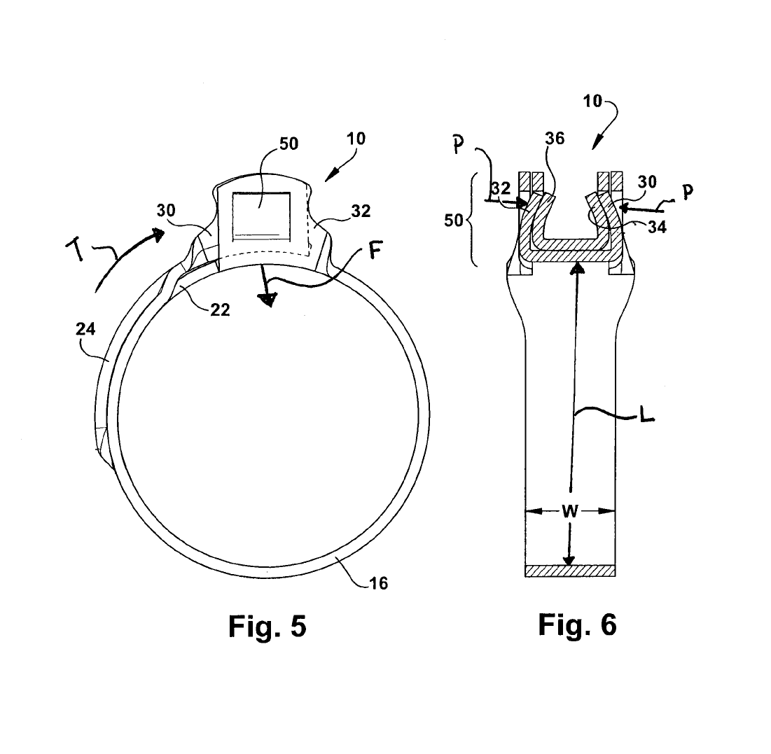

The second engaging portion 20 may include a first outer plate 30 and a second outer plate 32. The plates 30, 32 may be of any appropriate shape, size, type or configuration, such as of a generally square, semi-circular or rectangular planar configuration as shown in FIG. 2. The plates 30, 32 may also be of a similar shape and size, but are not limited to such. The first outer plate 30 and the second outer plate 32 may be located at any appropriate position on the clamp 10, such as at the second end 14, whereby the plates 30, 32 may be facing one another; see FIGS. 3 and 4. In some embodiments, the first outer plate 30 may be opposing the second outer plate 32. The first and second engaging portions 18, 20 may be utilized to move the clamp 10 from an open position—an example of which may be shown in FIG. 1—to a closed position—an example of which may be shown in FIG. 5.

While the plates 30, 32, 34, 36 may be shown as having substantially similar shapes and sizes, it is to be understood that each of the plates 30, 32, 34, 36 may have differing or corresponding shapes and sizes. In some embodiments, plates 30, 34 may be of a similar shape and size, while plates 32, 36 may each have a different and unique shape or size. In addition, while shown and discussed in terms of each engaging portion 18, 20 having two plates, it is to be understood that any appropriate number of plates may be utilized, such as one plate per engaging portion 18, 20, and should not be limited to those examples described herein.

The first outer plate 30 and second outer plate 32 of the second engaging portion 20 may be slightly more open than the first inner plate 34 and second inner plate 36 of the first engaging portion 18 as is shown in FIGS. 3 and 4. While shown with the plates 30, 32 of the second engaging portion 20 being more open than the plates 34, 36 of the first engaging portion 18 it is to be understood that the roles may be reversed. In other words, the plates 34, 36 of the first engaging portion 18 may be slightly more open than the plates 30, 32 of the second engaging portion 20.

In use, the relaxed state or open position may be any position in which the clamp 10 may be generally removable from the device 58 that it may be clamping, such as the airbag to the injector tube. The compressed state or closed position may be any position in which the clamp 10 may not be generally removable from the device 58 with which it may be clamping. The first and second engaging portions 18, 20 may overlap in the closed position, but may also overlap in an open position.

In some embodiments, the first and second engaging portions 18, 20 may be partially overlapped while allowing the clamp 10 to be generally removed from the device 58. In such embodiments, the clamp 10 may be in the open position. To move the clamp 10 in such embodiments to the closed position, the first and second engaging portions 18, 20 may be moved closer to one another such that clamp 10 may tighten a predetermined amount on the device 58. By way of a non-limiting example, the clamp 10 at the closed position may have a diameter substantially equal to that of the device 58.

In the closed or fully formed position, a substantial portion of one of the first or second engaging portions 18, 20 may overlap a substantial portion of the other first or second engaging portion 18, 20; see FIGS. 5 and 6. The first engaging portion 18 and the second engaging portion 20 may be moved such that the outer plates 30, 32 of the second engaging portion 20 may abut the inner plates 34, 36 of the first engaging portion 18. In some embodiments, one of the first or second engaging portions 18, 20 may be moved within the other engaging portion 18, as shown in FIGS. 3-6.

The clamp 10 may be secured in the closed position by any appropriate means, such as by attaching the plates 30, 32, 34, 36 together by crimping, puncturing, welding, using adhesives, fastening, using mechanical means, or the like; see FIGS. 5 and 6. In some embodiments, the plates 30, 32, 34, 36 may be secured by pinching or piercing the plates 30, 32, 34, and 36 together. The piercing of the plates 30, 32, 34, 36 may be in a direction substantially perpendicular to the load path of the clamp 10 and the length of the clamp 10. By way of a non-limiting example, the piercing of the plates 30, 32, 34, 36 may be as shown by P in FIG. 6, the load path of the clamp 10 may be shown by F in FIG. 5, and the length (or circumference) of the clamp 10 may be shown as L in FIG. 6. P may, therefore, be normal to both F and L. Moreover, the direction of the piercing of the plates 30, 32, 34, 36 may be done in a direction generally parallel to the width W of the clamp 10. Securing the clamp 10 in the closed position by applying force P in a direction substantially perpendicular to the load path F may increase the residual clamp load.

The plates 30, 32, 34, 36 may fasten or otherwise secure the engaging portions 18, 20 together, such as by puncturing, piercing or the like. It is to be understood that any appropriate number of the plates 30, 32, 34, 36 may be pierced. In some embodiments, all of the plates 30, 32, 34, 36 may be pierced. In other embodiments, however, one of the plates 30, 32, 34, 36 from each of the engaging portions 18, 20 may be pierced. A resulting pierced portion 50 may be bent into or through a portion of the engaging portions 18, 20 to lock the engaging portions 18, 20 together.

In some embodiments, the plates 30 and 34 may be pierced on one side whereby the pierced portion 50 of the plate 30 may be pushed through or at least partially into the pierced portion 50 of the plate 34; see FIGS. 5 and 6. In addition, the plates 32 and 36 may be pierced on the opposite side whereby the pierced portion 50 of the plate 32 may be pushed through or at least partially into the pierced portion 50 of the plate 36. In some embodiments, the pierced portion 50 of the plate 30 may be pushed through the plates 34 and 36.

The pierced portion of any of the plates 30, 32, 34, 36 may be pushed or inserted through any of the other plates 30, 32, 34, 36 so long as the engaging portions 18, 20 are securely locked together. At such a position, the engaging portions 18, 20 may lock the clamp 10 in the closed position to effectively secure and clamp, by way of a non-limiting example, the airbag to the inflating tube device 58. While described in terms of the plates 30 and 34 being pierced, it is to be understood that the opposite may also be true, such that plates 32 and 36 may be pierced whereby the pierced portion 50 of the plate 32 may be pushed through or at least partially into the pierced portion 50 of the plate 36. It is also to be understood that both sides of the engaging portions 18, 20 may be pierced.

The pierced portion 50 may be formed in any appropriate direction or angle, such as being moved in a direction substantially perpendicular P to the direction of the load path F of the clamp 10; see FIG. 6. The load path may typically occur along length of the clamp 10. Therefore, the first and second engaging portions 18, 20 may be engageable and lockable in a direction substantially perpendicular P to the length L of the clamp 10 and the direction of the load path F. The advantages of securing the clamp 10 at a closed position with forces perpendicular to the length of the clamp 10 and the load path may be significant.

Additional embodiments of the clamp 10 according the present teachings are described below. In the descriptions, all of the details and components may not be fully described or shown. Rather, some of the features or components are described and, in some instances, differences with the above-described embodiments may be pointed out. Moreover, it should be appreciated that these additional embodiments may include elements or components utilized in the above-described embodiments although not shown or described. Thus, the descriptions of these additional embodiments are merely exemplary and not all-inclusive nor exclusive. Moreover, it should be appreciated that the features, components, elements and functionalities of the various embodiments may be combined or altered to achieve a desired clamp without departing from the spirit and scope of the present teachings.

In other embodiments, the clamp 10 may be utilized with a fastener or stud 42 as shown in FIGS. 7-9. The clamp 10 may include a boss 38 and an aperture 40. The boss 38 may be of any appropriate shape, size, type or configuration, such as of a generally circular configuration as shown in FIGS. 7-9. The boss 38 may be located at any appropriate position on the clamp 10, such as being located along the annular ring portion 16 as shown in FIGS. 7-9. In these embodiments, the boss 38 may be centrally located along the width W of the annular ring portion 16 and may be located generally opposite that of the engaging portions 18, 20, but is not limited to such.

The aperture 40 may be of any appropriate shape, size, type or configuration, such as of a generally circular configuration, as shown in FIGS. 7-9. The aperture 40 may be located at any appropriate position on the clamp 10, such as located on an approximately central location within the boss 38 as further shown in FIGS. 7-9. The stud 42 may fit within or be located within the aperture 40 of the clamp 10. The stud 42 may include a head portion 44. The head portion 44 may rest within and abut the boss 38. The stud 44 may aid in assembly of the various components.

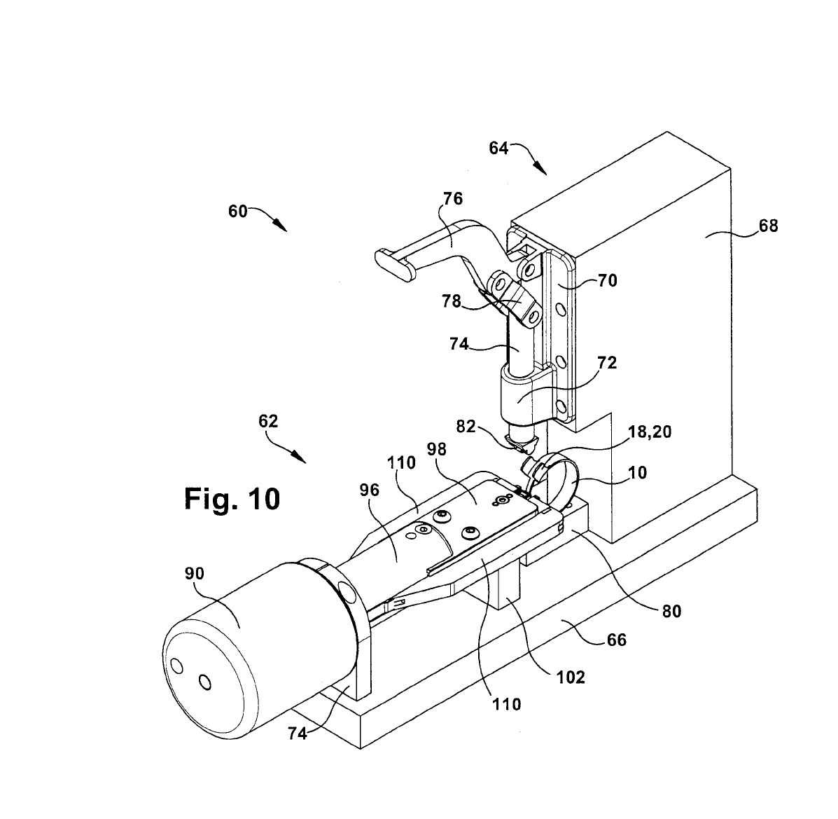

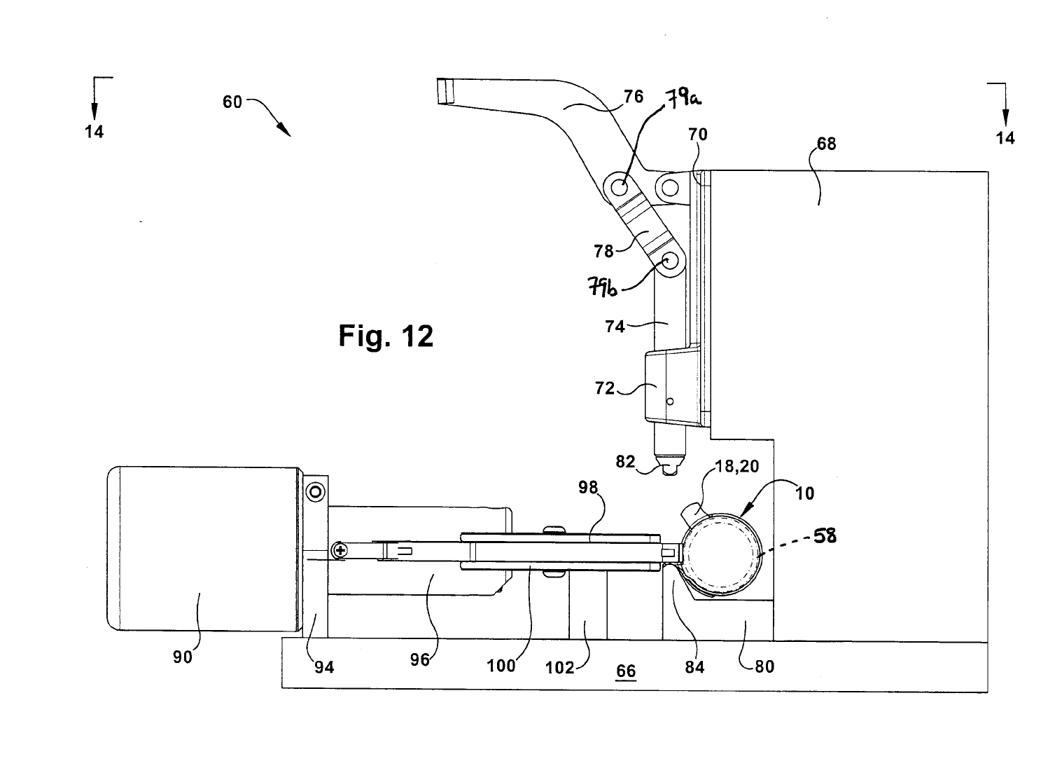

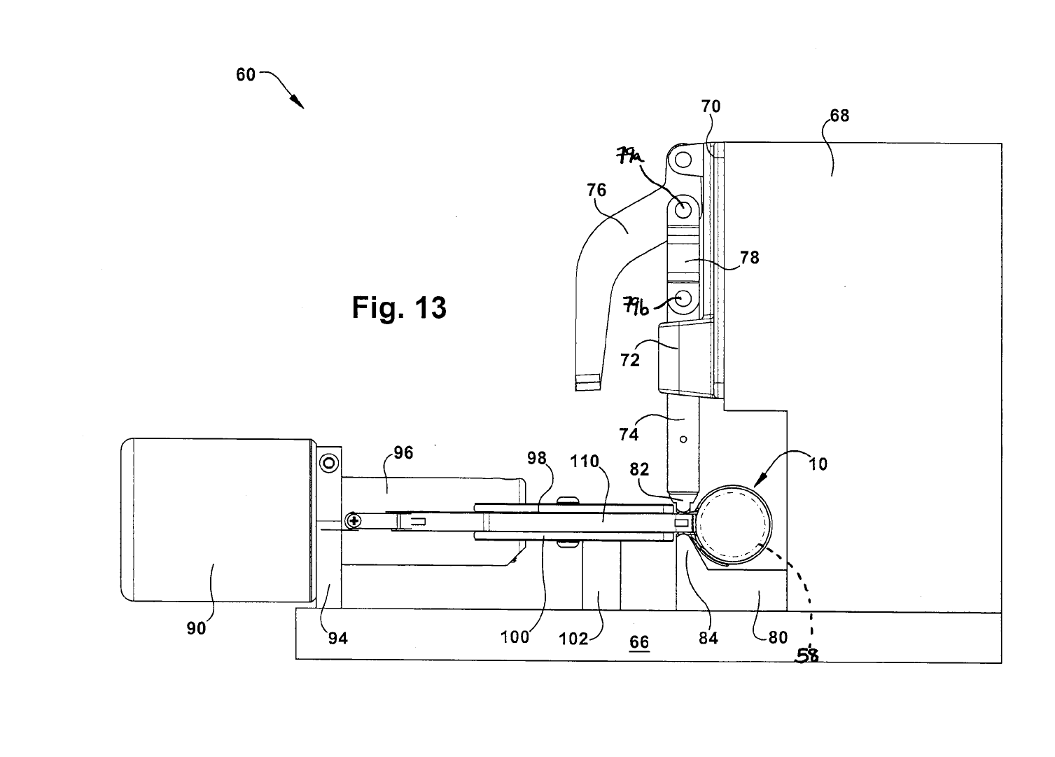

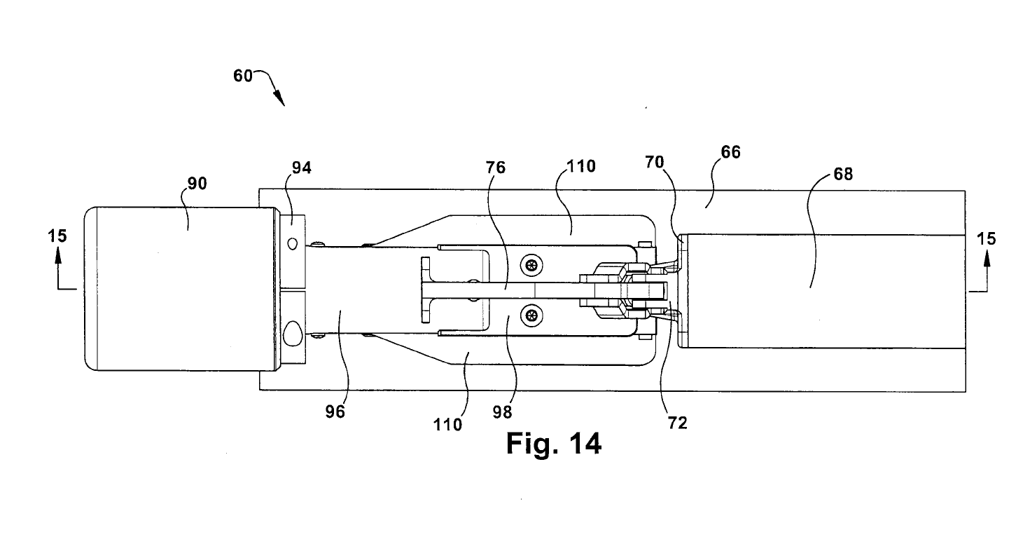

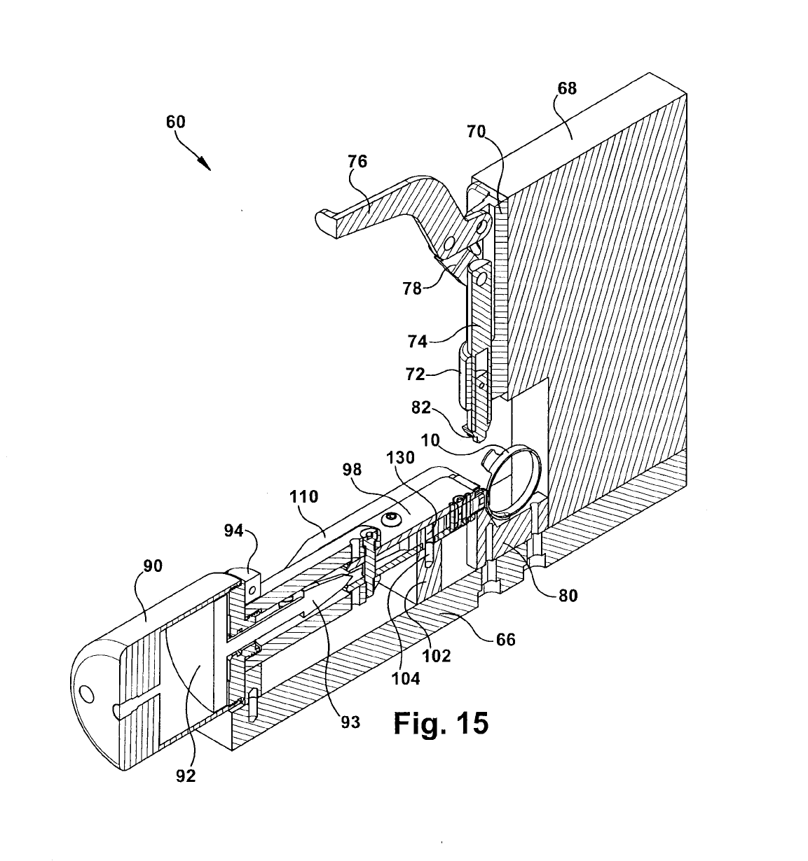

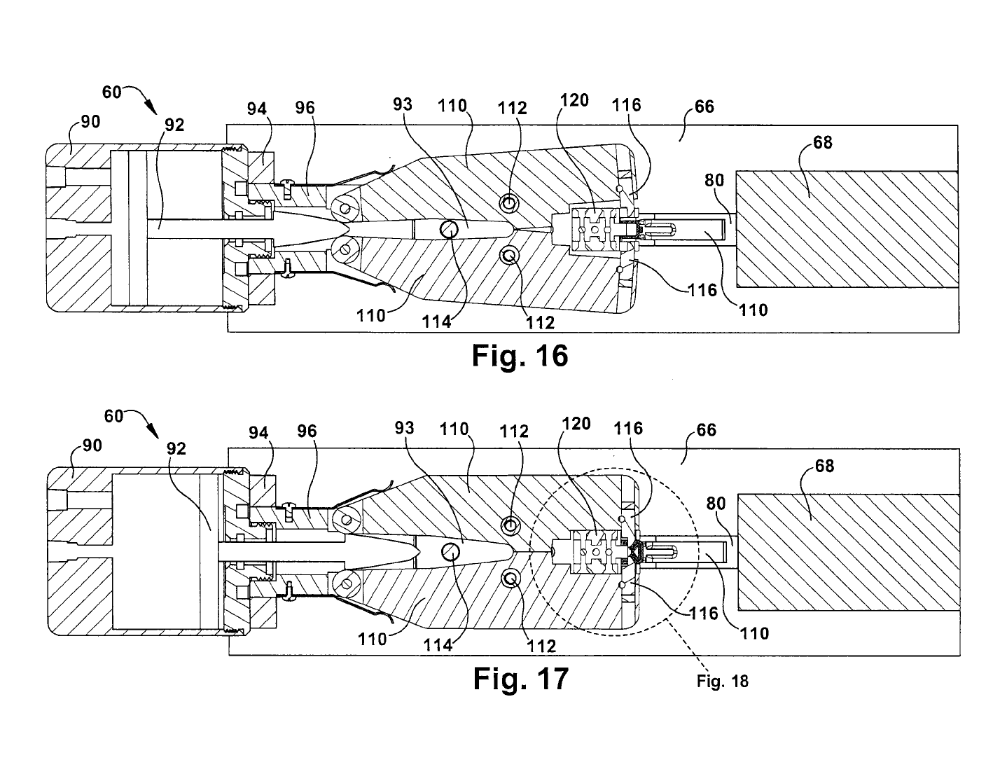

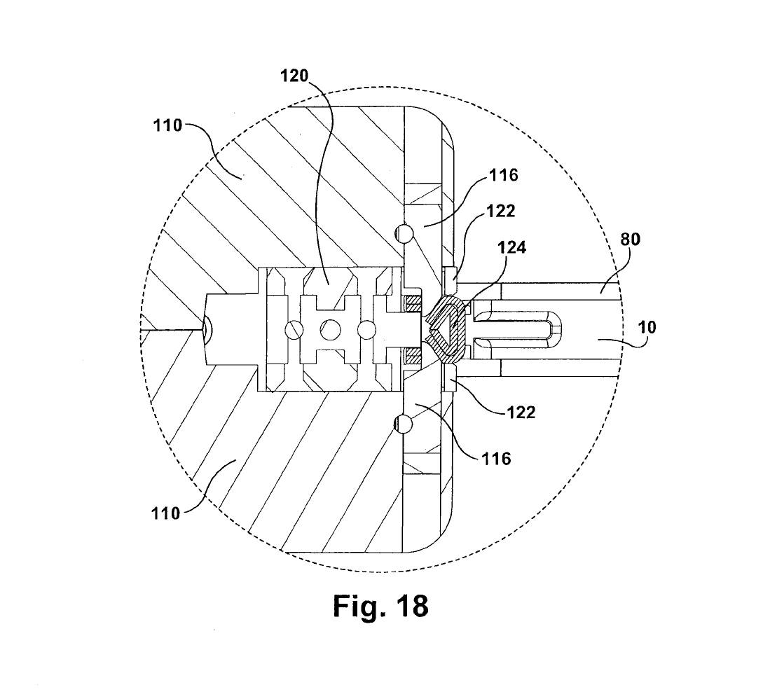

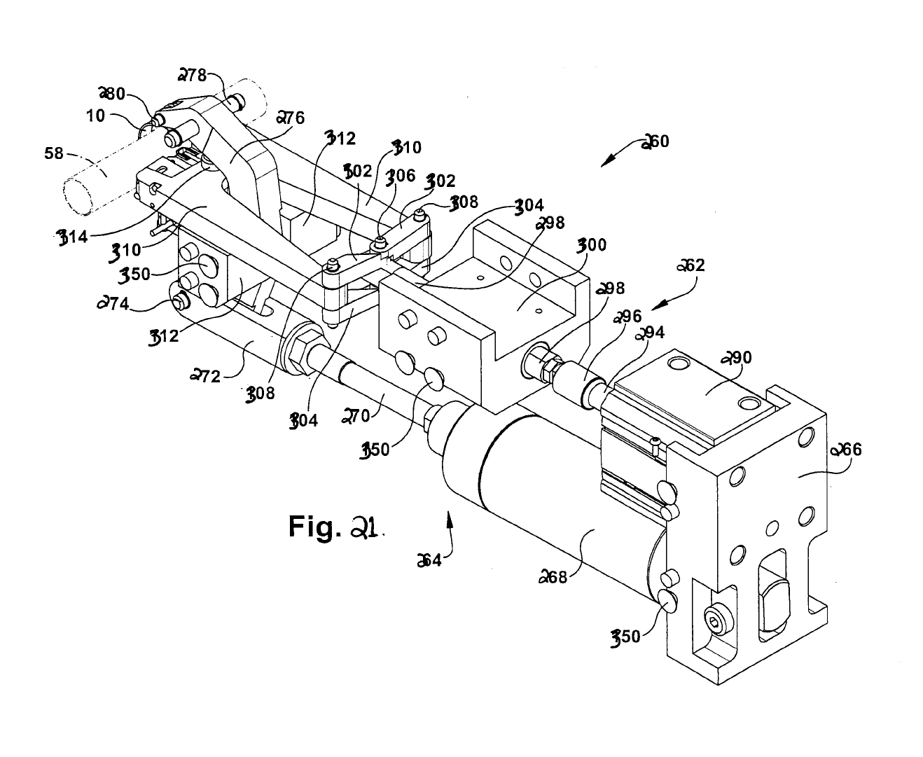

A clamp forming apparatus 60 is shown in FIGS. 10-20. The clamp forming apparatus 60 may be a manual clamp forming apparatus 60, which may be utilized for forming around and attaching or securing the clamp 10 to a device 58, such as a hose, tube, or any other appropriate device, by way of non-limiting examples. The manual clamp forming apparatus 60 may also pierce the plates 30, 32, 34, 36 of the engaging portions 18, 20 of the clamp 10.

The manual clamp forming apparatus 60 may be of any appropriate shape, size, type or configuration, such as a multi-directional tool for applying a generally tangential load around the circumference of the clamp 10 as well as pierce the engaging portions 18, 20 through themselves to lock the clamp 10 in place. The piercing P may be normal or perpendicular to the tangential load, thereby providing a solid one-piece locking clamp 10. Moreover, the clamp force may be fully adjustable.

The manual clamp forming apparatus 60 may be capable of being operatively positioned on a bench top such that the manual clamp forming apparatus 60 generally acts as bench top fixture. The manual clamp forming apparatus 60 may integrate the mechanisms for closing the clamp 10 and piercing the clamp 10. The manual clamp forming apparatus 60 may include a piercing assembly 62, a closure assembly 64 and a base plate 66. The piercing assembly 62 may be of any appropriate shape, size, type or configuration and is not limited to that shown and described herein. The piercing assembly 62 may be located at any appropriate position on the manual clamp forming apparatus 60, such as located generally above the base plate 66. The closure assembly 64 may be of any appropriate shape, size, type or configuration. The closure assembly 64 may be located at any appropriate position on the manual clamp forming apparatus 60, such as located generally above the base plate 66 and adjacent to the piercing assembly 62.

The base plate 66 may be of any appropriate shape, size, type or configuration, such as of a generally square or rectangular configuration. The base plate 66 may be fabricated out of any appropriate material, such as aluminum, steel, or the like. The base plate 66 may be located at any appropriate position on the manual clamp forming apparatus 60, such as located below the piercing assembly 62 and the closure assembly 64. The base plate 66 may generally secure both the piercing assembly 62 and the closure assembly 64 in place. The base plate 66 may also be mounted to a structure (not shown), such as a work bench, a fixture, or any suitable apparatus that may provide additional stability and/or operating room. The base plate 66 may align and stabilize the piercing assembly 62.

The closure assembly 64 may include a closure mount 68, a shaft mount 70, a shaft 74, and a closure handle 76. The closure mount 68 may be of any appropriate shape, size, type or configuration, such as of a generally square or rectangular configuration. The closure mount 68 may be fabricated out of any appropriate material, such as aluminum, steel or the like. The closure mount 68 may be located at any appropriate position on the manual clamp forming apparatus 60, such as located on a side of the base plate 66. The closure mount 68 may support the vertical operation of the closure tool 74 and handle 76.

The shaft mount 70 may be of any appropriate shape, size, type or configuration, such as of a generally square or rectangular configuration as shown in FIGS. 10-15. The shaft mount 70 may be located at any appropriate position on the manual clamp forming apparatus 60, such as located on an upper portion of the closure mount 68. In some embodiments, the shaft mount 70 may be located towards a generally central location of the base plate 66.

The shaft 74 may be of any appropriate shape, size, type or configuration, such as of a generally cylindrical configuration as shown in FIGS. 10-13. The shaft 74 may be located at any appropriate position on the closure assembly 64, such as engaged with the shaft mount 70. In some embodiments, the shaft 74 may generally be located in a perpendicular relationship to the base plate 66.

The closure handle 76 may be of any appropriate shape, size, type or configuration, such as of a generally curved configuration as shown in FIGS. 10-13. The closure handle 76 may be located at any appropriate position on the closure assembly 64, such as located toward an upper end of the closure mount 68. In some embodiments, closure handle 76 may be engaged with an upper end of the shaft mount 70.

The manual clamp forming apparatus 60 may include at least one linkage 78. In some embodiments, the manual clamp forming apparatus 60 may include a pair of linkages 78; however, any appropriate number of such may be utilized. The linkages 78 may be of any appropriate shape, size, type or configuration, such as of a generally rectangular configuration. The linkages 78 may be located at any appropriate position on the closure assembly 64, such as generally located between the closure handle 76 and the shaft 74. The linkages 78 may generally secure the shaft 74 to the closure handle 76 such that the closure handle 76 may actuate or otherwise pivot relative to the shaft 74.

The linkages 78 may include a pair of pivot pins 79a, 79b. The pivot pins 79a, 79b may be of any appropriate shape, size, type or configuration, such as a generally cylindrical shape. The pivot pins 79a, 79b may be located at any appropriate position on the linkages 78, whereby a first pivot pin 79a may secure an upper portion of the linkages 78 to the closure handle 76 and a second pivot pin 79b may secure a lower portion of the linkages 78 to the shaft 74.

The shaft mount 70 may include a guide 72. The guide 72 may be of any appropriate shape, size, type or configuration, such as of a generally cylindrical configuration as shown FIGS. 10-15. The guide 72 may be located at any appropriate position on the shaft mount 70, such as lower location on the shaft mount 70. The guide 72 may be a separate component or may be integrally formed with the shaft mount 70. The shaft 74 may be located through the guide 72, whereby the guide 72 may help guide and stabilize the shaft 74 as the motion of the shaft 74 is transferred to the clamp 10.

The shaft 74 may include an upper chuck 82. The upper chuck 82 may be of any appropriate shape, size, type or configuration, such as of a generally polygonal or rounded configuration. The upper chuck 82 may be located at any appropriate position on the shaft 74, such as generally located at a central bottom location near the base plate 66. In some embodiments, the upper chuck 82 may engage one of the first or second engaging portions 18, of the clamp 10, whereby the upper chuck 82 may aid in forming the clamp 10 around the device 58.

The manual clamp forming apparatus 60 may include a lower mount 80. The lower mount 80 may be of any appropriate shape, size, type or configuration, such as of a generally polygonal or rectangular configuration. The lower mount 80 may be located at any appropriate position on the manual clamp forming apparatus 60, such as generally located at a central location of the base plate 66. In some embodiments, the lower mount 80 may be located adjacent the closure mount 68.

The lower mount 80 may include a lower chuck 84. The lower chuck 84 may be of any appropriate shape, size, type or configuration, such as of a generally polygonal or rounded configuration. The lower chuck 84 may be located at any appropriate position on the lower mount 80, such as generally located at an upper position of the lower mount 80 and towards a side located away from the closure mount 68. In some embodiments, the lower chuck 84 may generally be located beneath the upper chuck 82 and aligned therewith. The lower chuck 84 may engage one of the first or second engaging portions 18, 20 of the clamp 10, whereby the lower chuck 84 may aid in forming the clamp 10 around the device 58.

In a non-limiting example, the closure handle 76 may be manually operated to drive the shaft 74 and its upper chuck 82 against one of the first or second engaging portions 18, 20 of the clamp 10. The upper chuck 82 may pull down or push one of the first or second engaging portions 18, 20 toward the other engaging portion 18, 20 to close the clamp 10. This may generally alter the clamp 10 from the relaxed state or open position to the compressed state or closed position. The engaging portion 18, 20 not moved by the upper chuck 82 may be held generally stationary by the lower chuck 84.

While the clamp 10 may have been shown and described as being placed in the manual clamp forming apparatus 60 in a certain manner, it is to be understood that the clamp 10 may be placed within the clamp forming apparatus 60 in any appropriate manner and should not be limited to that shown or described herein. In some embodiments, the upper chuck 82, lower chuck 84, and a clamp positioning insert 120 may hold the clamp 10 during the closure and piercing operations and may be designed to allow the clamp 10 to be inserted in either orientation. By way of a non-limiting example, either the first engaging portion 18 or the second engaging portion 20, or both may be inserted and placed within the clamp positioning insert 120.

The piercing assembly 62 may include an actuator such as pneumatic cylinder 90, a coupler 96 and at least one piercing arm 110. Although an air cylinder 90 is shown, it should be understood that any kind of pneumatic cylinder, hydraulic cylinder, or the like may be utilized without departing from the present teachings. In some embodiments, the piercing assembly 62 may include any appropriate number of piercing arms 110, such as a pair of piercing arms 110. The pneumatic cylinder 90 may be of any appropriate shape, size, type or configuration, such as of a generally square or rectangular configuration. The pneumatic cylinder 90 may be located at any appropriate position on the piercing assembly 62, such as located an end of the base plate 66 opposite that of the closure mount 68. The pneumatic cylinder 90 may include a shaft 92.

The manual clamp forming apparatus 60 may include a pneumatic cylinder mount 94 as shown in FIGS. 10-16 and 18. The pneumatic cylinder mount 94 may be of any appropriate shape, size, type or configuration, such as of a generally square or semi-circular configuration. The pneumatic cylinder mount 94 may include a central aperture 95. The central aperture 95 may be of any appropriate shape or size, such as of a generally circular shape. The central aperture 95 may be located at any appropriate position on the pneumatic cylinder mount 94, such as at a generally central location. The pneumatic cylinder mount 94 may be located at any appropriate position on the manual clamp forming apparatus 60, such as secured and located at an end of the base plate 66 opposite that of the closure mount 68. The pneumatic cylinder mount 94 may secure the pneumatic cylinder 90 thereto. In those embodiments that may utilize a generally different kind of pneumatic cylinder, hydraulic cylinder, or the like, an alternative mount may be used.

In operation, activating the pneumatic cylinder 90 may push the shaft 92 outwards from the pneumatic cylinder 90 and may engage the piercing arms 110. The shaft 92 may be of any appropriate shape, size, type or configuration, such as of a generally cylindrical configuration. The shaft 92 may be located at any appropriate position on the piercing assembly 62, such as located centrally to the pneumatic cylinder 90. The shaft 92 may extend outwardly from the pneumatic cylinder 90 and engage with the coupler 96.

The shaft 92 may include a cone 93. The cone 93 may be of any appropriate shape, size, type or configuration, such as of a generally conical configuration. The cone 93 may be located at any appropriate position on the shaft 92, such as located at an end of the shaft 92 opposite that of the pneumatic cylinder 90. The cone 93 may engage with the piercing arms 110 during the piercing operation.

The coupler 96 may be of any appropriate shape, size, type or configuration, such as of a generally cylindrical configuration towards one end and a planar configuration towards an opposite end. The coupler 96 may be located at any appropriate position on the piercing assembly 62, such as located between the pneumatic cylinder 90 and the piercing arms 110 as shown in FIGS. 10-16 and 18. In some embodiments, the coupler 96 may be attached to the housing 90 and may secure the piercing arms 110 at its planar end, whereby action by the shaft 92 may be transferred into action by the piercing arms 110. The coupler 96 may include an upper plate 98 and a lower plate 100.

The upper plate 98 may be of any appropriate shape, size, type or configuration, such as of a generally square or rectangular configuration. The upper plate 98 may be located at any appropriate position on the piercing assembly 62, such as located at the planar end of the coupler 96 and towards a generally central location on the base plate 66. For example, the upper plate 98 may be located above or otherwise in close proximity to the lower plate 100.

The lower plate 100 may be of any appropriate shape, size, type or configuration, such as of a generally square or rectangular configuration. The lower plate 100 may be located at any appropriate position on the piercing assembly 62, such as located at the planar end of the coupler 96 and towards a generally central location on the base plate 66 as shown in FIGS. 10-13. For example, the lower plate 100 may be generally aligned with and located below or otherwise in close proximity to the upper plate 98.

The manual clamp forming apparatus 60 may include a locating mount 102 as shown in FIGS. 10-13, 15 and 18. The locating mount 102 may be of any appropriate shape, size, type or configuration, such as of a generally square or rectangular configuration. The locating mount 102 may be located at any appropriate position on the manual clamp forming apparatus 60, such as located at a generally central location on the base plate 66 and adjacent to the lower mount 80.

The locating mount 102 may include at least one locating pin 104 and at least one stabilizing member 106. The locating pin 104 may be of any appropriate shape, size, type or configuration, such as of a generally cylindrical configuration. The locating pin 104 may be located at any appropriate position on the locating mount 102, such as located at a generally central location. The locating pin 104 may aid in positioning the lower plate 100 of the coupler 96, and thereby the piercing arms 110.

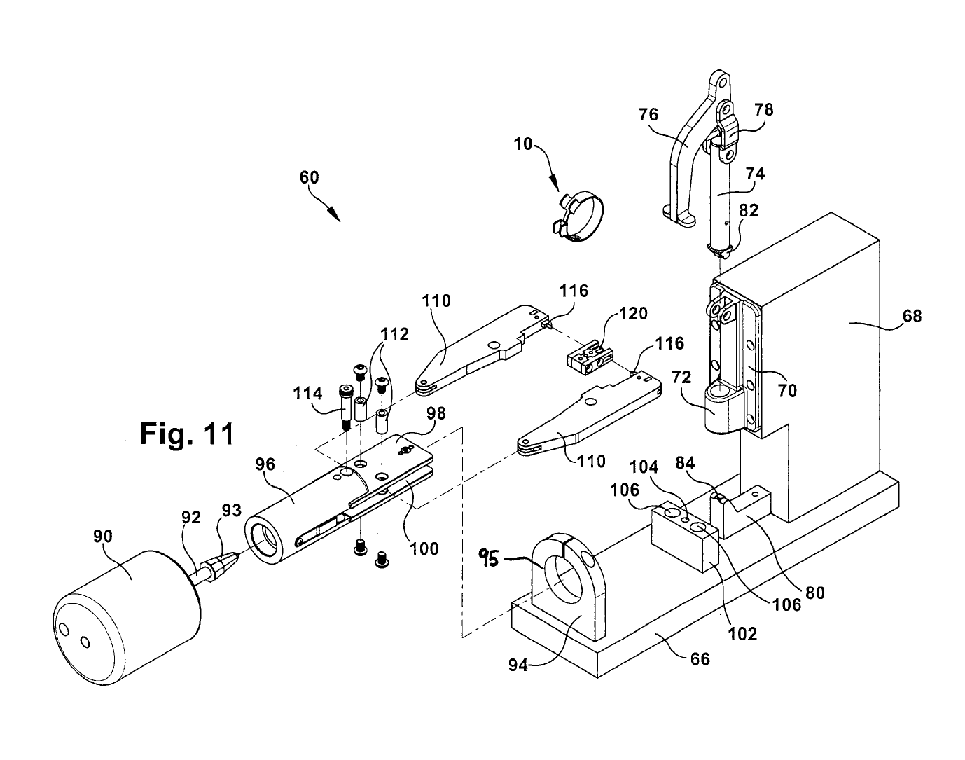

The stabilizing member 106 may be of any appropriate size, shape and construction and may generally maintain the piercing arms 110 in place. In some embodiments, the stabilizing member 106 may include a stabilizing magnet. The locating mount 102 may include any appropriate number of stabilizing magnets 106, such as a pair of magnet 106. The stabilizing magnets 106 may be of any appropriate shape, size, type or configuration, such as of a generally square, rectangular or circular configuration. The stabilizing magnets 106 may be located at any appropriate position on the locating mount 102, such as located adjacent and on each side of the locating pin 104 as shown in FIG. 11. The piercing arms 110 may be positioned by the locating pin 104 and maintained in place by the stabilizing magnets 106.

The piercing assembly 62 may include a locator 130. The locator 130 may be of any appropriate shape, size, type or configuration, such as of a generally square, rectangular or circular configuration. The locator 130 may be located at any appropriate position on the piercing assembly 62, such as on the lower plate 100 of the coupler 96. The locator 130 may be engaged with the locating pin 104 of the locating mount 102 to position the piercing arms 110.

The piercing assembly 62 may include pivot pins 112 and a central mount pin 114. The pivot pins 112 may be of any appropriate shape, size, type or configuration, such as of a generally cylindrical configuration. The pivot pins 112 may be located at any appropriate position on the piercing assembly 62, such as located through the upper plate 98 and lower plate 100 of the coupler 96 as shown in FIGS. 11, 16 and 18. The pivot pins 112 may secure the piercing arms 110 to the plates 98, 100 of the coupler 96.

The central mount pin 114 may be of any appropriate shape, size, type or configuration, such as of a generally cylindrical configuration. The central mount pin 114 may be located at any appropriate position on the piercing assembly 62, such as located through a generally central location of the coupler 96.

The piercing assembly 62 may include any appropriate number of piercing arms 110, such as a pair of arms 110. Each piercing arm 110 may be of any appropriate shape, size, type or configuration, such as of a generally polygonal, rectangular or triangular configuration. The piercing arms 110 may be located at any appropriate position on the piercing assembly 62, such as located within the upper plate 98 and lower plate 100 of the coupler 96 as shown in FIGS. 10, 11, 16 and 18. For example, the piercing arms 110 may be located above the locating mount 102.

Each piercing arm 110 may include a punch 116. The punch 116 may be of any appropriate shape, size, type or configuration, such as of a generally rectangular configuration with an angled or pointed end. The punch 116 may be located at any appropriate position on each piercing arm 110, such as located at a generally inner location towards an end of the piercing arms 110, whereby the angled or pointed end of the punch 116 may extend a distance outward from an edge of each piercing arm 110 as shown in FIGS. 11 and 16-18. For example, the punches 116 may be located at an end of each piercing arm 110 located adjacent to the lower mount 80.

The piercing assembly 62 may include the clamp positioning insert 120. The clamp positioning insert 120 may be of any appropriate shape, size, type or configuration, such as of a generally rectangular or square configuration. The clamp positioning insert 120 may be located at any appropriate position on the manual clamp forming apparatus 60, such as located on or within a generally central location between each piercing arm 110 as shown in FIGS. 11 and 16-19. In some embodiments, the clamp positioning insert 120 may be located between the upper plate 98 and lower plate 100 of the coupler 96. The clamp positioning insert 120 may be engaged with the clamp 10 during the piercing operation, such that at least one of the engaging portions 18, 20 of the clamp 10 may be held in a stationary position during the closure and piercing operations.

The clamp positioning insert 120 may provide support for the engaging portions 18, 20 of the clamp 10 during closure and piercing operations. The clamp positioning insert 120 may also provide clearance for the punches 116 during the piercing operation. The clamp 10 may be placed on the lower mount 80 while the clamp positioning insert 120 may be positioned on the locating pin 104 and is stabilized by the magnets 106.

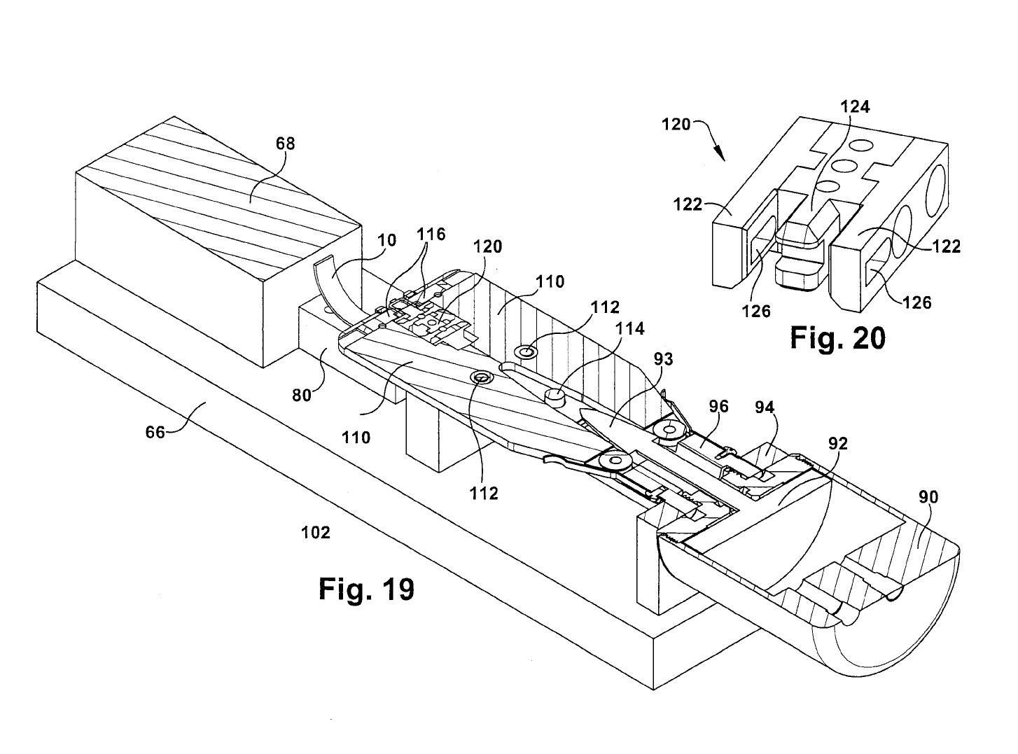

The clamp positioning insert 120 may include at least one outer support 122, such as a pair of outer supports 122, and a central support 124 as shown in FIG. 19. The outer supports 122 may be of any appropriate shape, size, type or configuration, such as of a generally planar rectangular or square configuration. The outer supports 122 may be located at any appropriate position on the clamp positioning insert 120, such as located on each side of the clamp positioning insert 120. The outer supports 122 may support the clamp 10, such as the engaging portions 18, 20, during closure and piercing operations. The outer supports 122 and central support 124 may generally prevent the engaging portions 18, 20 from an undesirable deformation during operation of the manual clamp forming apparatus 60.

Each outer support 122 may include a pierce aperture 126. The pierce apertures 126 may be of any appropriate shape, size, type or configuration, such as of a generally square or rectangular configuration. The pierce apertures 126 may be located at any appropriate position on the clamp positioning insert 120, such as located on each outer support 122 as shown in FIG. 19. The pierce apertures 126 may allow the punches 116 to be inserted therein to pierce the engaging portions 18, 20 of the clamp 10 during the piercing operation.

The central support 124 may be of any appropriate shape, size, type or configuration, such as of a generally square or rectangular configuration. The central support 124 may be located at any appropriate position on the clamp positioning insert 120, such as located at a generally central position on the clamp positioning insert 120 between the outer supports 122 as shown in FIG. 19. The clamp positioning insert 120 may provide support for the engaging portions 18, 20 of the clamp 10 during the closure of the clamp 10. After the clamp 10 is closed, the engaging portions 18, 20 of the clamp 10 may be pierced.

In some embodiments, the thrust of the shaft 92 in the pneumatic cylinder 90 may force the shaft 92 out of the pneumatic cylinder 90, whereby the movement of the shaft 92 and thereby the cone 93 may be transferred through the shaft 92 and into the coupler 96. As the cone 93 moves forward, the cone 93 may force the piercing arms 110 to pivot about the pivot pins 112, whereby the piercing arms 110 may force the punches 116 to pierce the engaging sections 18, 20 of the clamp 10.

The punches 116 of the piercing arms 110 may be located perpendicular or normal to the path of the closure load F of the clamp 10. This may result in the clamp 10 being pierced in a direction normal to the closure load. In some embodiments, the manual clamp forming apparatus 60 may apply a tangential load T around the circumference of the clamp 10 as well as pierce the engaging portions through themselves to lock the clamp 10. The piercing may be perpendicular or normal to the load, which may provide a solid one-piece locking clamp. This configuration may reduce any spring back of the clamp 10 after being formed. The manual clamp forming apparatus 60 may reduce the spring back of the formed clamp 10.

In some embodiments, the clamp 10 may be closed or formed onto the device 58 by manually pulling down on the handle 76. The closure handle 76 may be manually operated, such as by being pulled downward towards the clamp 10, whereby the handle 76 may drive the shaft 74 and its upper chuck 82 against one of the first or second engaging portions 18, 20 of the clamp 10. The lower mount 80 and lower chuck 84 may be located below the shaft 74 and upper chuck 82.

The upper chuck 82 may pull down or push one of the first or second engaging portions 18, 20 toward the other engaging portion 18, 20 to close the clamp 10, thereby altering the clamp 10 from the relaxed state or open position to the compressed state or closed position. The engaging portion 18, 20 not moved by the upper chuck 82 may be held stationary by the lower chuck 84.

While holding the clamp 10 in the closed position, the pneumatic cylinder 90 may be manually or automatically actuated by any appropriate means, whereby the piecing arms 110 may be engaged. The punches 116 of the piercing arms 110 may pierce the engaging portions 18, of the clamp 10. After the piercing operation, the piercing assembly 62 may be removed from the clamp 10 and the clamp 10 may be taken out of the manual clamp forming apparatus 60 by lifting the closure handle 76. This manual clamp forming apparatus 60 may or may not utilize any process monitoring technology.

Prior to use, the manual clamp forming apparatus 60 may be set to a predetermined distance. For example, the manual clamp forming apparatus 60 may be set to go or move up a certain distance. The manual clamp forming apparatus 60 may be fixed for a specific clamp 10 use such as by a trial and error measurement.

The clamp 10 may compress the desired component(s) (not shown) onto the device 58 using 360° of surface area. The manual clamp forming apparatus 60 may stretch the clamp 10 so that the distance across the engaged portions 18, 20 is the desired amount, thereby leaving a corresponding or desired amount of residual load. When typical clamps are formed via typical apparatus and methods, the clamp may be tightened to a pre-load of approximately 500 lbs, which may only leave a residual load of approximately 30 lbs. Unlike these typical clamp forming apparatus and method, and in a non-limiting example, the manual clamp forming apparatus 60 may tighten the clamp 10 to a pre-load of any appropriate amount, such as approximately 800 lbs, which may thereby leave a residual load of approximately 400-600 lbs of clamping force of the component(s) to the device 58.

The steps of the method of forming the clamp 10 through use of the manual clamp forming apparatus 60 described above may be accomplished in any appropriate order and are not limited to the order stated above. Steps may be skipped and/or rearranged to form the clamp 10 by utilizing the manual clamp forming apparatus 60.

Additional embodiments of a clamp forming apparatus according the present teachings are described below. In the descriptions, all of the details and components may not be fully described or shown. Rather, some of the features or components are described and, in some instances, differences with the above-described embodiments may be pointed out. Moreover, it should be appreciated that these additional embodiments may include elements or components utilized in the above-described embodiments although not shown or described. Thus, the descriptions of these additional embodiments are merely exemplary and not all-inclusive nor exclusive. It should be appreciated that the features, components, elements and functionalities of the various embodiments may be combined or altered to achieve a desired clamp forming apparatus without departing from the spirit and scope of the present teachings. Still further, while the manual clamp forming apparatus 60 is discussed above and the automatic clamp forming apparatus 260 is discussed below, it should be understood that the elements and components of each may be interchanged. This may result in a clamp forming apparatus that may be combine certain elements and components from the manual clamp forming apparatus 60 and the automatic clamp forming apparatus 260 to form a suitable clamp forming apparatus.

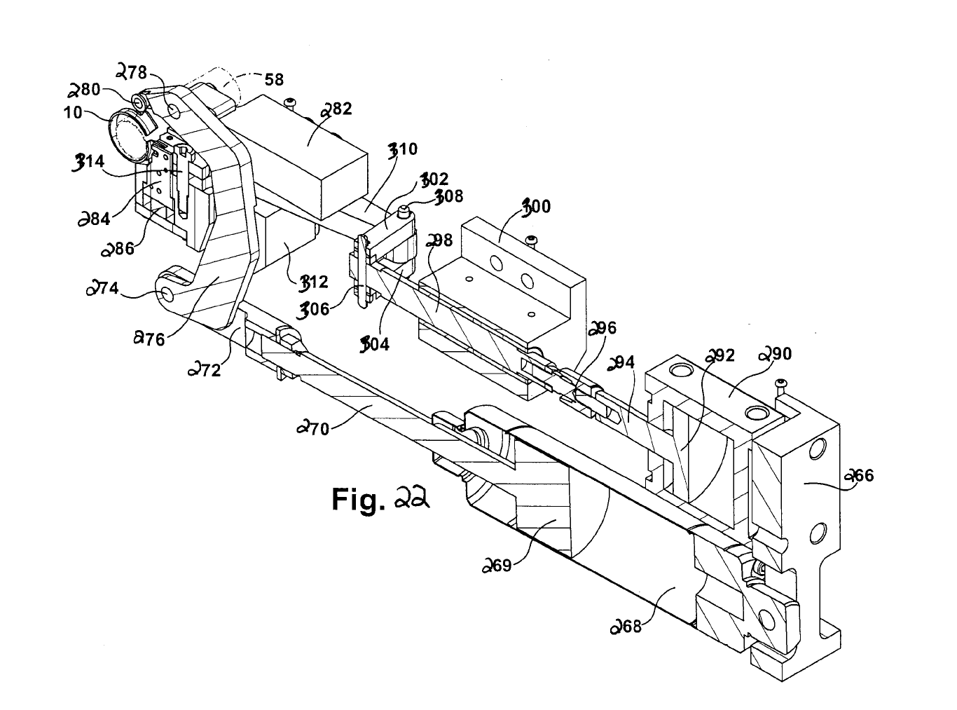

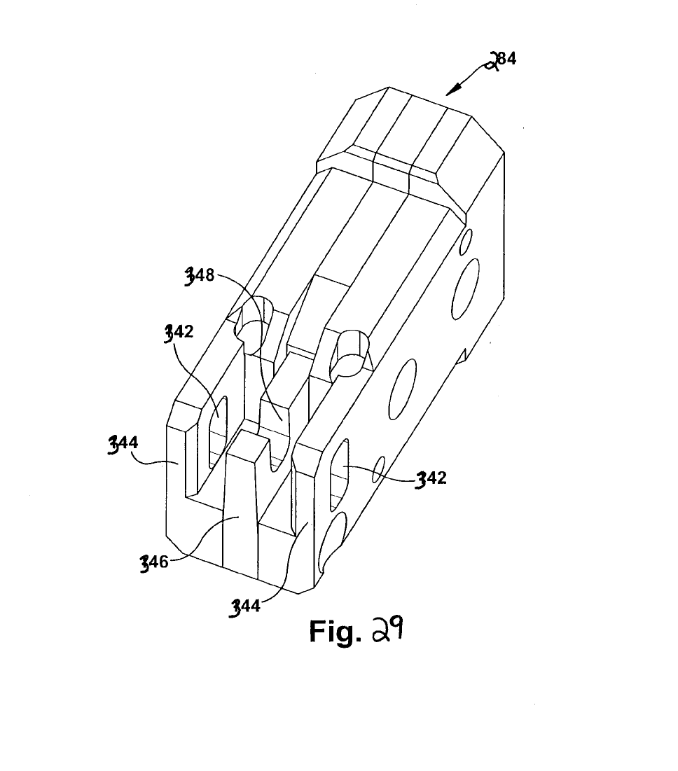

Other embodiments of a clamp forming apparatus 260 are illustrated in FIGS. 21-30, which may be an automatic clamp forming apparatus 260. The automatic clamp forming apparatus 260 may be utilized for forming around and attaching or securing the clamp 10 to a device 58, such as a hose or tube, by way of a non-limiting example. The automatic clamp forming apparatus 260 may also pierce the plates 30, 32, 34, 36 of the engaging portions 18, 20 of the clamp 10. The automatic clamp forming apparatus 260 may be operated by any appropriate means, such as by being actuated using a computer or processing device (not shown) such that the operation may be automated.

The automatic clamp forming apparatus 260 may be of any appropriate shape, size, type or configuration, such as a multi-directional tool for applying a tangential load T around the circumference of the clamp 210 as well as operatively securing, such as through piercing, the engaging portions 218, 220 through themselves to lock the clamp 210 in place. The piercings may be normal or perpendicular to the load, thereby providing a solid one-piece locking clamp 210. Moreover, the clamp force may be fully adjustable and predeterminable.

The automatic clamp forming apparatus 260 may include a piercing assembly 262, a closure assembly 264 and an end plate 266, as show in FIG. 21. The piercing assembly 262 may be of any appropriate shape, size, type or configuration. The piercing assembly 262 may be located at any appropriate position on the apparatus 260, such as located generally above the closure assembly 264. The closure assembly 264 may be of any appropriate shape, size, type or configuration. The closure assembly 264 may be located at any appropriate position on the apparatus 260, such as located generally below the piercing assembly 262.

The end plate 266 may be of any appropriate shape, size, type or configuration, such as of a generally square or rectangular configuration. The end plate 266 may be located at any appropriate position on the apparatus 260, such as located at one end of the apparatus 260. The end plate 266 may secure the piercing assembly 262 above the closure assembly 264. The end plate 266 may also be mounted to a structure (not shown), which may provide additional stability to the automatic clamp forming apparatus 260.

The piercing assembly 262 may include an actuator, such as a pneumatic cylinder 290, a coupling 296, a guide rod 298 and at least one piercing arm 310. The pneumatic cylinder 290 may be of any appropriate shape, size, type or configuration, such as of a generally square or rectangular configuration; see FIGS. 21-26 and 30. The actuator may be any appropriate actuator—in addition to a pneumatic cylinder 290 such as an air cylinder—the actuator may be a hydraulic cylinder. The pneumatic cylinder 290 may be located at any appropriate position on the piercing assembly 262, such as located adjacent and secured to the end plate 266, see FIGS. 21-26. The pneumatic cylinder 290 may include a piston 292 and a shaft 294.

The piston 292 may be of any appropriate shape, size, type or configuration, such as of a generally cylindrical configuration. The piston 292 may be located at any appropriate position on the pneumatic cylinder 290. The piston 292 may push the shaft 294 outwards from the pneumatic cylinder 290. The shaft 294 may be of any appropriate shape, size, type or configuration, such as of a generally cylindrical configuration; see FIGS. 21, 23 and 34. The shaft 294 may be located at any appropriate position on the piercing assembly 262, such as located centrally to the pneumatic cylinder 290. The shaft 294 may extend outwardly from the pneumatic cylinder 290 and may engage with the coupling 296.

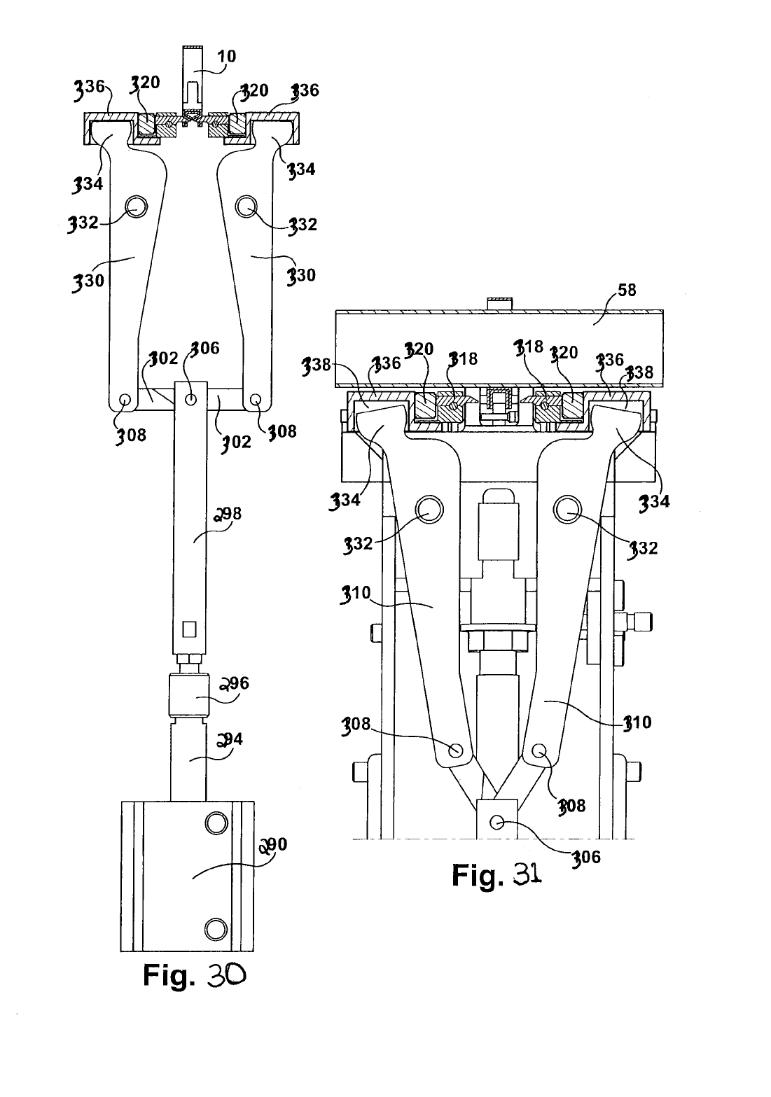

The coupling 296 may be of any appropriate shape, size, type or configuration, such as of a generally cylindrical configuration shown in FIGS. 21 and 30. The coupling 296 may be located at any appropriate position on the piercing assembly 262, such as located between the shaft 294 and the guide rod 298, as shown in FIGS. 21-26 and 19. By way of a non-limiting example, the coupling 296 may secure the shaft 94 and the guide rod 298 together, whereby action by the shaft 294 may be transferred into action by the guide rod 298.

The guide rod 298 may be of any appropriate shape, size, type or configuration, such as of a generally cylindrical configuration, see FIGS. 21-24. The guide rod 298 may be located at any appropriate position on the piercing assembly 262, such as adjacent to and connected to the coupling 296.

The piercing assembly 262 may include a guide block 300. The guide block 300 may be of any appropriate shape, size, type or configuration, such as of a generally square or rectangular configuration; see FIGS. 21-26. The guide block 300 may be located at any appropriate position on the piercing assembly 262, such as located between the pneumatic cylinder 290 and the piercing arms 310. The guide rod 298 may be located through the guide block 300, whereby the guide block 300 may help guide and stabilize the guide rod 298 as the motion of the shaft 294 is transferred into motion of the piercing arms 310.

The piercing assembly 262 may also include a plurality of linkages 302, 304. The linkages 302, 304 may be of any appropriate shape, size, type or configuration, such as of a generally rectangular configuration; see FIGS. 21-26, 30 and 31. The linkages may include upper linkages 302 and lower linkages 304. There may be any appropriate number of linkages 302, 304, whereby there may be a pair of upper linkages 302 and a pair of lower linkages 304. The linkages 302, 304 may be located at any appropriate position on the piercing assembly 262, such that the upper linkages 302 may be located above the lower linkages 304 and there may be a set of an upper linkage 302 and lower linkage 304 located to each side of the guide rod 298.

The linkages 302, 304 may be secured to one another and pivot about a central pivot pin 306 and outer pivot pins 308. The central pivot pin 306 may be of any appropriate shape, size, type or configuration, such as of a generally cylindrical configuration, see FIGS. 21-26, 30 and 31. The central pivot pin 306 may be located at any appropriate position on the piercing assembly 262, such as located generally in line with the guide rod 298. The central pivot pin 306 may secure a first end of the two sets of upper linkages 302 and lower linkages 304 to one another and to the guide rod 298.

The outer pivot pins 308 may be of any appropriate shape, size, type or configuration, such as of a generally cylindrical configuration; see FIGS. 21-26, 30 and 31. The outer pivot pins 308 may be located at any appropriate position on the piercing assembly 262, such as located at a second or opposite end of the set of linkages 302, 304. By way of a non-limiting example, there may be one outer pivot pin 308 located to a first side and securing the first set of upper and lower linkages 302, 304 to one another, and there may be a second outer pivot pin 308 located to a second side and securing the second set of upper and lower linkages 302, 304 to one another, see FIGS. 21, 23, 25 and 26.

The piercing assembly 262 may include any appropriate number of piercing arms 310, such as a pair of arms 310. Each piercing arm 310 may be of any appropriate shape, size, type or configuration, such as of a generally triangular configuration; see FIGS. 21, 23, 25 and 26. The piercing arms 310 may be located at any appropriate position on the piercing assembly 262, such as located towards each side of the guide rod 298; see FIGS. 21, 23, 25 and 26. By way of a non-limiting example, the piercing arms 310 may generally circumscribe a closure arm 276.

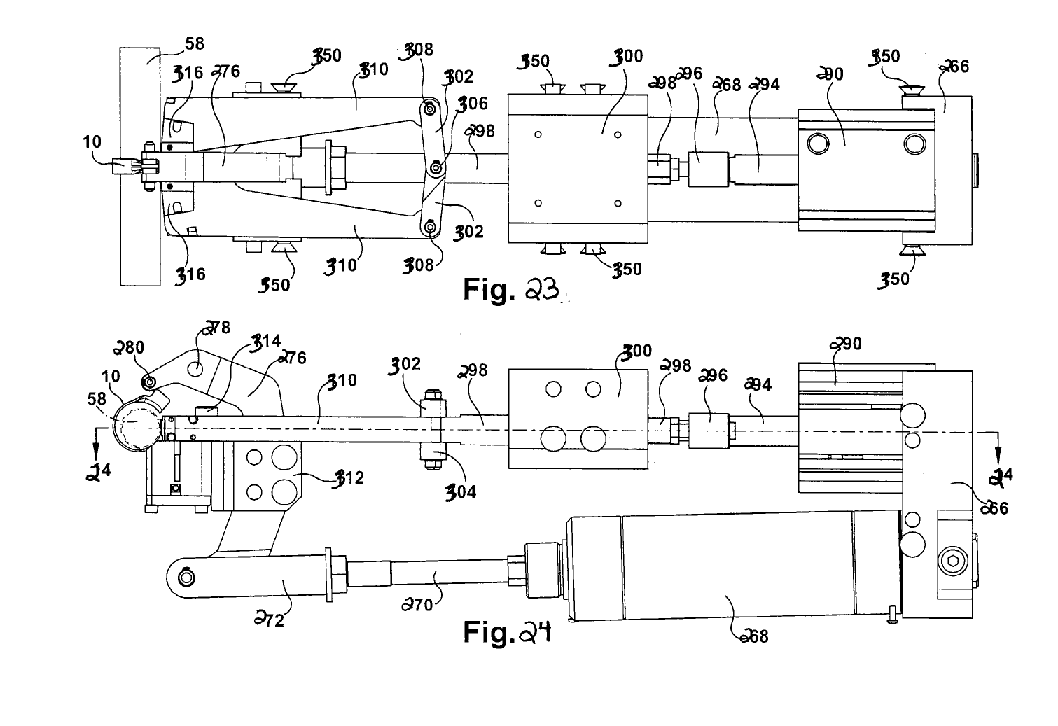

The piercing assembly 262 may include at least one pivot block 282 and a pivot pin 314. The pivot block 282 may be of any appropriate shape, size, type or configuration, such as of a generally square or rectangular configuration; see FIG. 22. The piercing assembly 262 may include a pair of pivot blocks 282. The pivot blocks 282 may be located at any appropriate position. By way of a non-limiting example, one pivot block 282 may be located on each side adjacent to and above each piercing arm 310.

Each piercing arm 310 may include an engagement section 316, or only one such piercing arm 310 may include the engagement section 316. The engagement sections 316 may be of any appropriate shape, size, type or configuration, such as of a generally square or rectangular configuration; see FIGS. 23 and 25-28. The engagement sections 316 may be located at any appropriate position on the piercing assembly 262, such as located towards an end of the piercing assembly 262 opposite the end plate 266. The engagement sections 316 may be located at an end opposite that where the outer pivot pins 308 are located. By way of a non-limiting example, the engagement sections 316 may be located adjacent to the device 258 to be clamped.

The pivot pin 314 may be of any appropriate shape, size, type or configuration, such as of a generally cylindrical configuration; see FIGS. 21 and 24-28. The pivot pin 314 may be located at any appropriate position on the piercing assembly 262, such as located on one of the piercing arms 310; see FIGS. 21 and 24-28. By way of a non-limiting example, the pivot pin 314 may be located on one of the piercing arms 310 generally behind its engagement section 316.

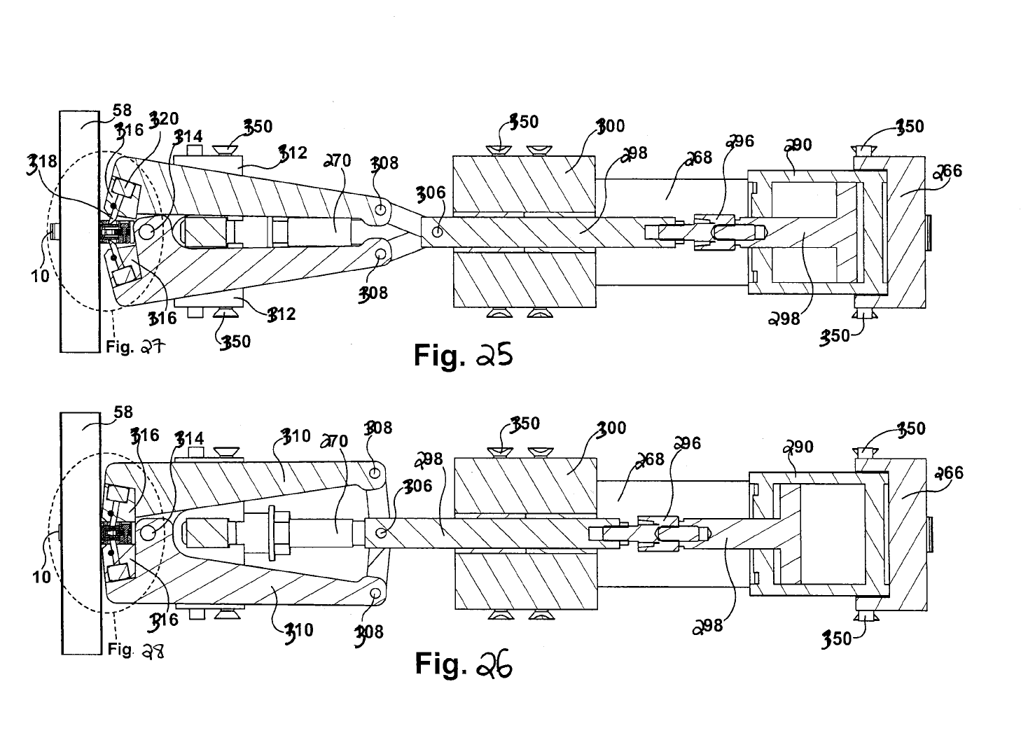

Each engagement section 316 may include a punch 318 and a load cell 320. The punch 318 may be of any appropriate shape, size, type or configuration, such as of a generally rectangular, circular, oval or the like configuration with an angled or pointed end; see FIGS. 25-28. The punch 318 may be located at any appropriate position on each engagement section 316, such as located at a generally central location on each engagement section 316, whereby the angled or pointed end of the punch 318 may generally extend a distance outward from each engagement section 316 and its associated piercing arm 310; see FIGS. 25-28.

The load cell 320 may be of any appropriate shape, size, type or configuration, such as of a generally square or rectangular configuration; see FIGS. 25-28. The load cell 320 may be located at any appropriate position on each engagement section 316, such as located directly behind each punch 318; see FIGS. 25-28. By way of a non-limiting example, both punches 318 may have load cells 320 to determine the load while piercing the clamp 210, as shown in FIG. 25. During the piercing operation, the force of both punches 318 may be measured. Alternatively, only a single load cell 320 may be utilized.

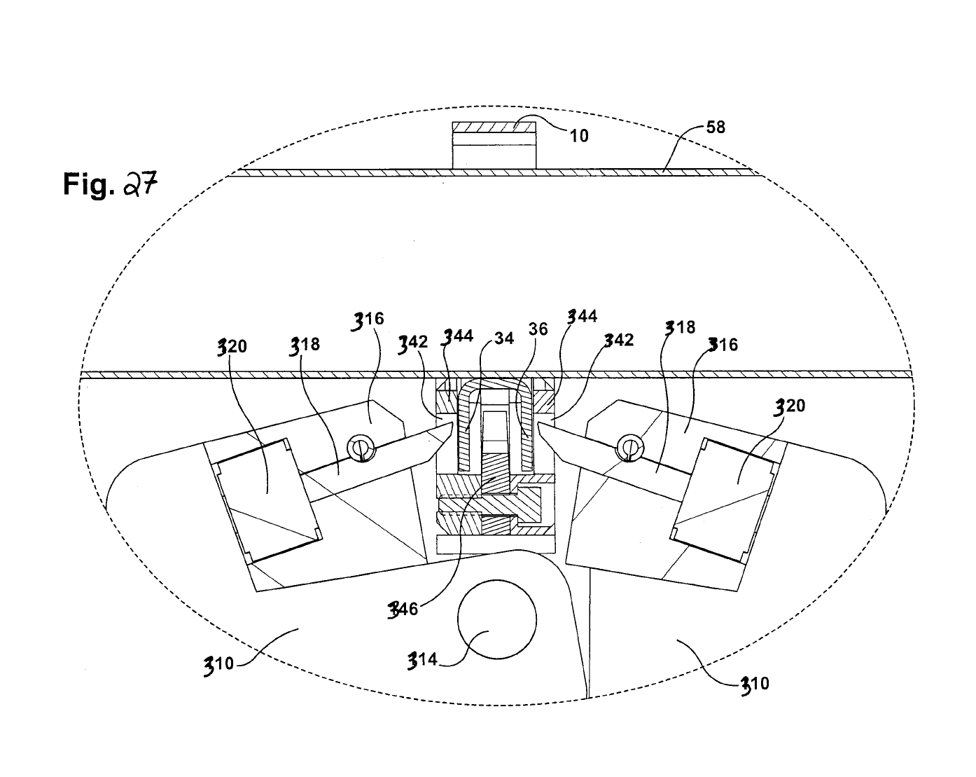

In a non-limiting example, the thrust of the piston 292 in the pneumatic cylinder 290 may force the shaft 294 out of the pneumatic cylinder 290, whereby the movement of the shaft 294 may be transferred through the coupling 296 and into the guide rod 298. As the guide rod 298 moves forward, the guide rod 298 may force the linkages 302, 304 to pivot about the central pivot pin 306 and the outer pivot pins 308, whereby the piercing arms 310 may further rotate about pivot pin 314; see FIGS. 25 and 26. This movement of the piercing arms 310 may force the punches 318 to engage, such as through piercing, the engaging sections 218, 220 of the clamp 210.

Additional embodiments of the automatic clamp forming apparatus according the present teachings are described below. In the descriptions, all of the details and components may not be fully described or shown. Rather, some of the features or components are described and, in some instances, differences with the above-described embodiments may be pointed out. Moreover, it should be appreciated that these additional embodiments may include elements or components utilized in the above-described embodiments although not shown or described. Thus, the descriptions of these additional embodiments are merely exemplary and not all-inclusive nor exclusive. Moreover, it should be appreciated that the features, components, elements and functionalities of the various embodiments may be combined or altered to achieve a desired automatic clamp forming apparatus without departing from the spirit and scope of the present teachings.

In other embodiments, the piercing assembly 262 may include at least one piercing arm 330, as shown in FIGS. 30 and 31. There may be any appropriate number of piercing arms 330, such as a pair of piercing arms 330. Each piercing arm 330 may include a pivot pin 332. Each piercing arm 330 may be of any appropriate shape, size, type or configuration, such as of a generally triangular configuration as shown in FIGS. 30 and 31. The piercing arms 330 may be located at any appropriate position on the piercing assembly 262, such as located towards each side of the guide rod 298; see FIGS. 30 and 31. By way of a non-limiting example, the piercing arms 330 may surround the closure arm 276.

Each piercing arm 330 may include a knuckle 334. Each knuckle 334 may be of any appropriate shape, size, type or configuration, such as of a generally triangular, square or rectangular configuration; see FIGS. 30 and 31. Each knuckle 334 may be located at any appropriate position on the piercing arms 330, such as located towards an end of each piercing arm 330 opposite the location of the outer pivot pins 308. By way of a non-limiting example, the engagement sections 316 may be located adjacent the device 258 to be clamped.

Each knuckle 334 may be engaged with a slide 336. The slides 336 may be of any appropriate shape, size, type or configuration, such as of a generally square or rectangular configuration, see FIGS. 30 and 31. Each slide 336 may be located at any appropriate position on the piercing assembly 262, such as located above the mounting block 312. Each slide 336 may include a punch 318 and a load cell 320. The punch 318 may be of any appropriate shape, size, type or configuration, such as of a generally rectangular configuration with an angled or pointed end as shown in FIGS. 30 and 31. The punch 318 may be located at any appropriate position on each slide 336, such as located at a generally inner location on each slide 336, whereby the angled or pointed end of the punch 318 may extend a distance outward from each slide 336; see FIGS. 30 and 31.

The load cell 320 may be of any appropriate shape, size, type or configuration, such as of a generally square or rectangular configuration as shown in FIGS. 30 and 31. The load cells 320 may be located at any appropriate position on each slide 336, such as located directly behind each punch 318 as shown in FIGS. 30 and 31. Both punches 318 may have load cells 320 to determine the load while piercing the clamp 210. During the piercing operation, the force from both punches 318 may be measured. The load cell 320 may be operatively coupled with a computer or other processing device to provide the appropriate and relevant information.

The slide 336 may include a knuckle slot 338. The knuckle slots 338 may be of any appropriate shape, size, type or configuration, such as of a generally square or rectangular configuration as shown in FIGS. 30 and 31. By way of a non-limiting example, each knuckle slot 338 may be of a shape and size to receive each knuckle 334. Each knuckle slot 338 may be located at any appropriate position on the slides 336, such as located at an end opposite that of the punch 318, whereby the load cell 320 may be located between the punch 318 and the knuckle slot 338.

Each pivot pin 332 may be of any appropriate shape, size, type or configuration, such as of a generally cylindrical configuration as shown in FIGS. 30 and 31. Each pivot pin 332 may be located at any appropriate position on each piercing arm 330; see FIGS. 30 and 31. By way of a non-limiting example, each pivot pin 332 may be located at a generally central location on each piercing arms 330 generally towards the slides 336.

In a non-limiting example, the thrust of the piston 292 in the pneumatic cylinder 290 may force the shaft 294 out of the pneumatic cylinder 290, whereby the movement of the shaft 294 may be transferred through the coupling 296 and into the guide rod 298. As the guide rod 298 may move forward, the guide rod 298 may force the linkages 302, 304 to pivot about the central pivot pin 306 and the outer pivot pins 308, whereby the piercing arms 330 may further rotate about each pivot pin 332. This movement of the piercing arms 330 about the pivot pins 332 may force the knuckles 334 of the piercing arm 330 to engage with the knuckle slots 338 of the slides 336; see FIGS. 30 and 31. As the knuckles 334 engage the knuckle slots 338, that movement may force the slides 336 to move inwardly towards one another, whereby that movement forces the punches 318 to pierce the engaging sections 218, 220 of the clamp 210.

The piercing assembly 262 and punches 318, as utilized by both piercing arms 310, 330, may be located perpendicular or normal to the path of the closure load of the clamp 210, whereby the clamp 210 may be pierced in a direction normal to the closure load as shown in FIGS. 5 and 6. This configuration may reduce any spring back of the clamp 210 after being formed. The automatic clamp forming apparatus 260 may reduce the spring back of the formed clamp 210.

The closure assembly 264 may include an actuator, such as a pneumatic cylinder 268, a linkage 272, and a closure arm 276; see FIGS. 21, 22 and 24. The actuator may be a hydraulic cylinder or the like and the pneumatic cylinder 268 may include an air cylinder. The pneumatic cylinder 268 may be of any appropriate shape, size, type or configuration, such as of a generally cylindrical configuration as shown in FIGS. 21, 22 and 24. The pneumatic cylinder 268 may be located at any appropriate position on the closure assembly 264, such as located generally adjacent to and may be secured to the end plate 266; see FIGS. 21-26. The pneumatic cylinder 268 may include a piston 269 and a shaft 270.

The piston 269 may be of any appropriate shape, size, type or configuration, such as of a generally cylindrical configuration. The piston 269 may be located at any appropriate position on the pneumatic cylinder 268. The piston 269 may push the shaft 270 outwards from the pneumatic cylinder 268. The shaft 270 may be of any appropriate shape, size, type or configuration, such as of a generally cylindrical configuration as shown in FIGS. 21, 22 and 24. The shaft 270 may be located at any appropriate position on the closure assembly 264, such as located centrally to the pneumatic cylinder 268. The shaft 270 may extend outwardly from the pneumatic cylinder 268 and engage with the linkage 272.

The linkage 272 may be of any appropriate shape, size, type or configuration, such as of a generally U-shaped configuration as shown in FIG. 21. The linkage 272 may be located at any appropriate position on the closure assembly 264, such as adjacent to and connected to the shaft 270. The linkage 272 may include a pivot pin 274. The pivot pin 274 may be of any appropriate shape, size, type or configuration, such as a generally cylindrical shape as shown in FIGS. 21, 22 and 24. The pivot pin 274 may be located at any appropriate position on the linkage 272, such as at an end generally opposite that of the shaft 270 location and generally through the slotted end.

The closure arm 276 may be of any appropriate shape, size, type or configuration, such as of a generally curved or C-shaped configuration as shown in FIGS. 21, 22 and 24. The closure arm 276 may be located at any appropriate position on the closure assembly 264, such as by way of a non-limiting example located to be engaged with the pivot pin 274 and located within the slotted end of the linkage 272; see FIGS. 21, 22 and 24. By way of a non-limiting example, closure arm 276 may extend upwardly from the linkage 272. The closure arm 276 may also be located in between the two piercing arms 310.

The closure arm 276 may include an upper pivot pin 278 and a roller 280; see FIGS. 21, 22 and 24. The upper pivot pin 278 may be of any appropriate shape, size, type or configuration, such as of a generally cylindrical configuration as shown in FIGS. 21, 22 and 24. The upper pivot pin 278 may be located at any appropriate position on the closure assembly 264, such as generally located at an upper position on the closure arm 276; see FIGS. 21, 22 and 24. By way of a non-limiting example, the upper pivot pin 278 may engage the pivot block 282 so that as the closure arm 276 pivots forward and downward via the pivot pin 278, the pivot block 282 provides a basis off of which the closure arm 276 and pivot pin 278 may pivot.

The roller 280 may be of any appropriate shape, size, type or configuration, such as of a generally cylindrical configuration as shown in FIGS. 21, 22 and 24. The roller 280 may be located at any appropriate position on the closure arm 276, such as generally located at a central location of a forward most location of the closure arm 276; see FIGS. 21, 22 and 24. By way of a non-limiting example, the roller 280 may engage an outer section of the first engaging portion 218.

In a non-limiting example, the closure arm 276 may move to drive the roller 280 against the clamp 210; see FIGS. 22 and 24. The roller 280 may pull down or push one of the first or second engaging portions 218, 220 toward the other engaging portion 218, 220 to close the clamp 210. This alters the clamp 210 from the relaxed state or open position to the compressed state or closed position. The engaging portion 218, 220 not moved by the roller 280 may be held stationary by a clamp positioning insert 284; see FIG. 22.

The automatic clamp forming apparatus 260 may also include at least one mounting block 312; see FIGS. 21-24 and 25. By way of a non-limiting example, the automatic clamp forming apparatus 260 may include a pair of mounting blocks 312. The mounting blocks 312 may be of any appropriate shape, size, type or configuration, such as of a generally square or rectangular configuration as shown in FIGS. 21-24 and 25. The mounting blocks 312 may be located at any appropriate position on the automatic clamp forming apparatus 260, such as located on each side of the closure arm 276; see FIGS. 21-24 and 25. By way of a non-limiting example, the mounting blocks 312 may be located below the pivot block 282. The mounting blocks 312 may extend forward and in front of a portion of the closure arm 276. While described as being two mounting blocks 312, it is to be understood that there may be one mounting block 312 that may extend in front of and around both sides of the closure arm 276.

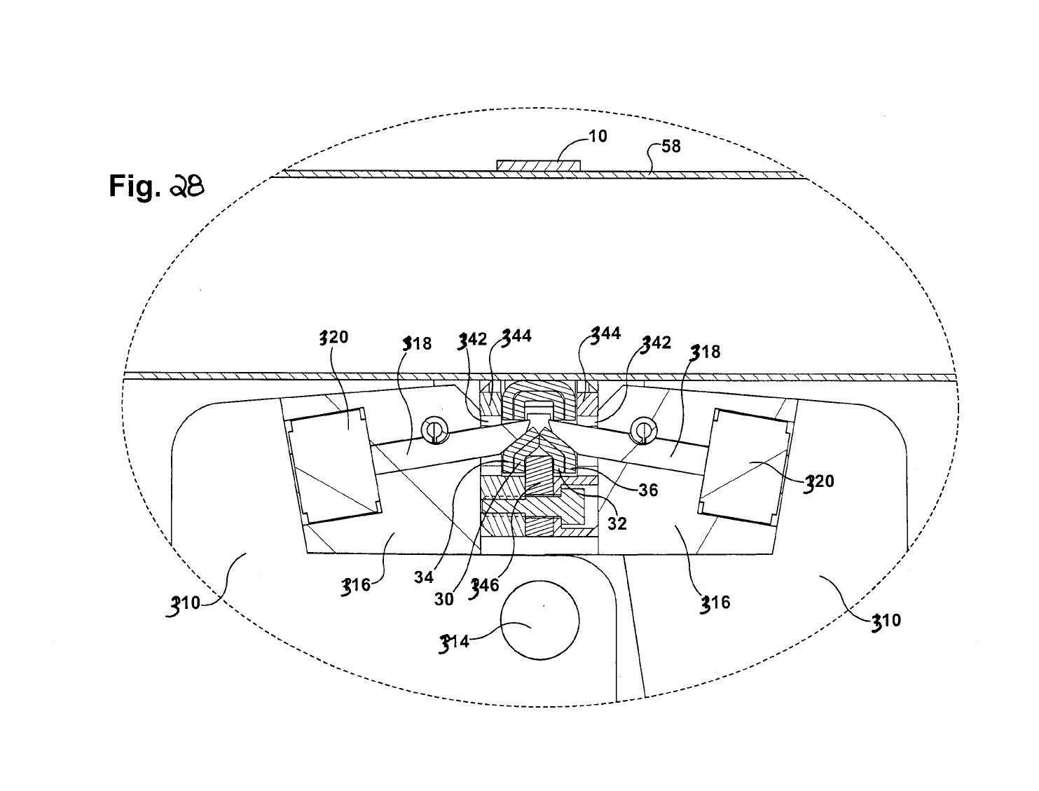

The mounting block 312 may include a clamp positioning insert 284, see FIGS. 22 and 29. The clamp positioning insert 284 may be of any appropriate shape, size, type or configuration, such as of a generally rectangular or square configuration as shown in FIGS. 22 and 29. The clamp positioning insert 284 may be located at any appropriate position on the automatic clamp forming apparatus 260, such as located on or within the mounting block 312; see FIGS. 22 and 29. By way of a non-limiting example, the clamp positioning insert 284 may be located adjacent the device 258 to be clamped, whereby the clamp position insert 284 may hold the clamp 210, such by way of a non-limiting example, as the second engaging portion 220 of the clamp 210, in a stationary position during the closure and piercing operations. The clamp positioning insert 284 may include at least one outer support 344, such as a pair of outer supports 344, and a central support 346; see FIGS. 27-29.

The outer supports 344 may be of any appropriate shape, size, type or configuration, such as of a generally planar rectangular or square configuration as shown in FIGS. 27-29. The outer supports 344 may be located at any appropriate position on the clamp positioning insert 284, such as located on each side of the clamp positioning insert 284 towards an upper end of the insert 284; see FIGS. 27-29. The outer supports 344 may support the clamp 210, such as the second engaging portion 220, during the closure and piercing operations and may generally prevent undesired deformation to the clamp 210 during operation of the automatic clamp forming apparatus 260.

Each outer support 344 may include a pierce aperture 342. The pierce apertures 342 may be of any appropriate shape, size, type or configuration, such as of a generally square, circular, rectangular or the like configuration as shown in FIGS. 27-29. The pierce apertures 342 may be located at any appropriate position on the clamp positioning insert 284, such as located at a generally central location on each outer support 344; see FIGS. 27-29. The pierce apertures 342 may allow the punches 318 to be inserted therein to pierce the engaging portions 218, 220 of the clamp 210 during the piercing operation.

The central support 346 may be of any appropriate shape, size, type or configuration, such as of a generally square, circular, rectangular or the like configuration as shown in FIGS. 27-29. The central support 346 may be located at any appropriate position on the clamp positioning insert 284, such as located at a generally central position on the clamp positioning insert 284; see FIGS. 27-29. By way of a non-limiting example, the outer supports 344 and the central support 346 may provide slots for the engaging portions 218, 220 of the clamp 210 to be held therein during closure and piercing operations, which may generally prevent undesired deformation.

The central support 346 may include a pierce slot 348. The pierce slot 348 may be of any appropriate shape, size, type or configuration, such as of a generally square, circular, rectangular or the like configuration; see FIG. 29. The pierce slot 348 may be located at any appropriate position on the clamp positioning insert 284, such as located at a generally central location on the central support 346; see FIG. 29. The pierce slot 348 may allow the punches 318 to be inserted therein during the piercing operation.

While the clamp 210 of present application may have been shown and described as being placed in the automatic clamp forming apparatus 260 in a certain manner, it is to be understood that the clamp 210 may be placed within the clamp forming apparatus 260 in any appropriate manner and should not be limited to that shown or described herein. By way of a non-limiting example, the clamp positioning insert 284 that may hold the clamp 210 during the closure and piercing operations may allow the clamp 210 to be inserted in either orientation. By way of a non-limiting example, either the first engaging portion 218 or the second engaging portion 220 may be inserted and placed within the clamp positioning insert 284.

The closure assembly 264 may include at least one load cell 286; see FIG. 22. The load cell 286 may be of any appropriate shape, size, type or configuration, such as of a generally cylindrical, square or rectangular configuration; see FIG. 22. The load cell 286 may be located at any appropriate position on the closure assembly 264, such as located directly below the clamp positioning insert 284; see FIG. 22. During the closure operation, the clamp positioning insert 84 may transfer the load or force from the clamp 210 into the load cell 286, whereby the force and travel used by the closure arm 276 to close the clamp 210 may be measured. The load cell 286 may be operatively coupled with a computer or other processing device to provide the appropriate and relevant information.

The automatic clamp forming apparatus 260 may also include a plurality of mounting fasteners 350; see FIGS. 21, 23 and 25. The mounting fasteners 350 may be of any appropriate shape, size, type or configuration, such as of a generally circular, square, rectangular or the like configuration; see FIGS. 21, 23 and 25. The mounting fasteners 350 may be located at any appropriate position on the automatic clamp forming apparatus 260, such as located on a each side of the end plate 266, guide block 300, and mounting blocks 312; see FIGS. 21, 23 and 25.

The mounting fasteners 350 may secure a plate (not shown) to each side of the automatic clamp forming apparatus 260, whereby the internal working components 262, 264 may be generally covered. The plates may extend along the length of each side of the apparatus 260. The plates may also provide additional structure to the automatic clamp forming apparatus 260. The plates, however, may not be so secured.

As discussed above, the automatic clamp forming apparatus 210 may consist of two distinct mechanisms, the piercing assembly 262 and the closure assembly 264; see FIG. 21. The closure assembly 264 may close and hold the clamp 210 while the piercing assembly 262 may pierce the engaging portions 218, 220 of the clamp 210 as described in more detail above. The closure assembly 264 may be actuated by the pneumatic cylinder 268 and may be designed to travel to a positive stop.

In a non-limiting example, during assembly, an airbag component may be positioned over the injector tube device 258, the clamp 210 may be aligned to secure the airbag to the injector tube device 258, and the clamp 210 may be moved from the open position to the closed position via the roller 280 of the closure assembly 264. The roller 280 may be connected to the load cell 286 for measuring the amount of force applied to the first or second engaging portion 218, 220 and/or the amount of spring back force on the engaging portion 218, 220. The load cells 320 connected to the piercing arms 310, 330 may measure the force applied or realized by the piercing arms 310, 330 as the engaging portions 218, 220 are pierced. These load cells 286, 320 may be operatively coupled with a computing device or any appropriate processing device. The load cells 286, 320 may provide

The automatic clamp forming apparatus 260 may be connected to a processor (not shown) and/or a database (not shown) to control the forces applied to and distances traveled of the clamp 210 during the closure and piercing operations. The processor and/or the database may record the forces, travel, and time in which the forces occurred and link the information to the clamp 210. The resulting data may then be stored and analyzed. Additionally, using the measure of distance traveled by the clamp 210, the load applied to the clamp 210, or both, the success or failure of the clamping of the clamp onto the device 258 may be determined. In some embodiments, both the distance traveled by the clamp 210 and the load applied to the clamp may be used to determine the success of the process of clamping 210 the clamp to the device 258.

By way of a non-limiting example, the piercing assembly 262 may pierce the engaging portions 218, 220 of the clamp 210. The piercing assembly 262 may be actuated by any actuating device or mechanism, such as by way of a non-limiting example, the pneumatic cylinder 290, or alternatively by a hydraulic cylinder. Both of the pierce arms 310, 330 may be mechanically linked, whereby both pierce arms 310, 330 may travel at the same speed and distance relative to one another. The piercing assembly 262 may utilize load cells 320 or other sensing devices to determine the amount of force applied in piercing the engaging portions 218, 220, the distance the engaging portions 218, 220 may have moved, force applied to pierce the engaging portions 218, 220, and the distance in which the pierced portion 250 may be moved by the piercing assembly 262.

The load cells 320 of the piercing assembly 262 may be positioned generally behind each of the punches 318. The output of each load cell 320 may be used by the process monitor to create another set of control parameters or control window. When the punches 318 are the same, the force the punches 318 exert on the load cells 320 may be nearly the same as they travel into the clamp 210. If the punches 318 are not nearly the same, the force they exert on the load cells 320 may be different as they travel into the clamp 210. The process monitor may detect the differences between the two load cells 320 output throughout the cycle and may consider the cycle non-conforming if the force profiles fall outside of the programmed operating parameters or window.

Further, the load cell 320 may be connected to the database and/or the processor for recording the amount of force and the distance traveled. The processor and/or the database may be used to ensure the amount of force at a given distance applied to the engaging portions 218, 220 of the clamp 210 for a sufficiently adequate joint. By way of a non-limiting example, use of the load cell 320, the processor and/or the database may permit the automatic clamp forming apparatus 260 to detect a mis-built assembly and resulting poor joint after piercing the engaged portions 218, 220.

By way of additional non-limiting examples, the load cell 286 may be connected to the database and/or the process for recording the force and distance traveled. The processor and/or the database may be used to ensure the amount of force at a given distance applied by the closure arm 276 is sufficient to close the clamp 210. Use of the load cell 286, the processor and/or the database may permit the automatic clamp forming apparatus 260 to detect a mis-built assembly and resulting poor joint before piercing the engaged portions 218, 220.

The clamp 210 may compress the desired component(s) (not shown) onto the device 258 using 360° of surface area. The automatic clamp forming apparatus 260 may tighten the clamp 210 to a desired pre-load amount, thereby leaving a corresponding or desired amount of residual load. When typical clamps are formed via typical apparatus and methods, the clamp may be tightened to a pre-load of approximately 500 lbs, which may only leave a residual load of approximately 30 lbs. Unlike these typical clamp forming apparatus and method, and in a non-limiting example, the automatic clamp forming apparatus 260 may tighten the clamp 10 to a pre-load of any appropriate amount, such as approximately 800 lbs, which may thereby leave a residual load of approximately 400-600 lbs of clamping force of the component(s) to the device 258.

The automatic clamp forming apparatus 260 may actively control and monitor a number of different variables and characteristics, including, but not limited to, how much force is need to pierce, how much force was used to pierce, how much distance is needed to close, how much distance was traveled, how much load is needed to close, how much load was used to close, etc. The automatic clamp forming apparatus 260 may measure these variables with real time data feedback, whereby the apparatus 260 and the processor may use this date to ensure the part was processed correctly. For instance, if the clamp force and travel are not correct the processor may reject the part before piercing. The part may otherwise be reused. This may simplify rework.

If there is not enough load/force or travel, the apparatus 260 may not pierce the clamp 210. By way of a non-limiting example, if the piercing assembly 262 does not travel enough or the desired distance, a good pierce may not result. There must also be enough load at the desired distance to be traveled in order to have the clamp 210 adequately pierced. In addition, after the piercing operation, the punches 318 may be removed from the clamp 210, when the clamp 210 is released, the load cell 286 data may be reviewed to determine how much force was released from the clamp 210. If the same amount of force is released from the clamp 210 as was applied, there was likely a bad piercing. The automatic clamp forming apparatus 260 may monitor how much force is on the load cells 286 as it releases.

The travel distance may be monitored by a linear variable differential transformer (LVDT) (not shown) and the position may be output to the process monitor. The LVDT may be located at any appropriate position on the automatic clamp forming apparatus 260, such as within the pneumatic cylinder 268. The closure assembly 264 may work together with the load cell 286 located below the clamp positioning insert 284 for the clamp 210. The process monitor may utilize the force signal supplied by the load cell 286 and the distance signal supplied by the LVDT to generate a signature or curve that may represent a unique profile for each clamping cycle.

Each of these individual cycle profiles may be compared to a control profile that may have been developed during testing. A set of parameters for allowable process variation may also have been developed, whereby if any of the individual clamp cycles falls outside of the set of parameters, the clamp cycle may be considered non-conforming. The load cell 286 and LVDT may also be used to confirm that each clamp 210 was properly pierced. If the clamp 210 is properly pierced, the clamp 210 may not “push back” against the closure arm 276 when the closure arm 276 is retracted after the clamp cycle. If the clamp 210 is not properly pierced, the load cell 286 may output a force as the closure arm 276 moves away from the clamp 210.

The steps of the method of forming the clamp 210 through use of the automatic clamp forming apparatus 260 described above may be accomplished in any appropriate order and are not limited to the order stated above. Steps may be skipped and/or rearranged to form the clamp 210 by utilizing the automatic clamp forming apparatus 60.

Although the embodiments of the present teachings have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

1. A clamp forming apparatus capable of forming a clamp, the clamp having first and second engaging portions, the clamp forming apparatus comprising:
at least one securing member;
a clamp positioning device operatively engaged with the at least one securing member, wherein at least one of the first or second engaging portions is supported by the clamp positioning device; and
wherein a tangential load is applied around a circumference of the clamp and the at least one securing member secures at least one of the engaging portions of the clamp together in a direction generally normal to the tangential load.

2. The clamp forming apparatus of claim 1, wherein the securing member comprises at least one piercing arm.

3. The clamp forming apparatus of claim 2 further comprising a pair of piercing arms.

4. The clamp forming apparatus of claim 3, wherein the pair of piercing arms is operable by an actuator.

5. The clamp forming apparatus of claim 4, wherein each of the pair of piercing arms each include a punch capable of piercing the engaging portions of the clamp in a direction normal to the tangential load.

6. The clamp forming apparatus of claim 1 further comprising a base having a closure assembly.

7. The clamp forming apparatus of claim 6, wherein the closure assembly includes:
a first chuck;
a shaft secured to the first chuck; and
a second actuator capable of selectively axially positioning the first chuck to apply the tangential load around the circumference of the clamp.

8. The clamp forming apparatus of claim 7, wherein the second actuator operates to raise and lower the first chuck into engagement with the clamp.

9. The clamp forming apparatus of claim 8 further comprising a mount capable of selectively securing one of the first and second engaging portions wherein the first chuck is engageable with the other of the first or second engaging portions.

10. The clamp forming apparatus of claim 9, wherein the mount includes a second chuck, wherein the first chuck engages with one of the first or second engaging portions and moves the engaging portion toward the other of the first or second engaging portion to close the clamp, wherein the engaging portion not moved by the first chuck is held stationary by the second chuck.

11. The clamp forming apparatus of claim 10 further comprising a locating mount secured to the base.

12. The clamp forming apparatus of claim 11, wherein the locating mount includes at least one locating feature to position the at least one securing member.

13. The clamp forming apparatus of claim 12, wherein the at least one locating feature includes a locating pin.

14. The clamp forming apparatus of claim 1, wherein the at least one securing member secures the engaging portions of the clamp together in a direction generally parallel to a width of the clamp.

15. A clamp forming apparatus for forming a clamp having first and second engaging portions, the clamp forming apparatus comprising:
a mount removably securing one of the first or second engaging portions generally in place;
a clamp positioning device, wherein at least one of the first or second engaging portions is supported by the clamp positioning device; and
a securing member operatively engaged with the clamp positioning device, wherein a tangential load is applied around a circumference of the clamp, and wherein the securing member secures at least one of the engaging portions of the clamp in a direction normal to the tangential load.

16. The clamp forming apparatus of claim 15 further comprising an actuator operatively connected with the securing member, wherein the securing member includes a pair of piercing arms selectively positionable by the actuator.

17. The clamp forming apparatus of claim 16 further comprising a closure member selectively axially positionable by a second actuator to position the other of the first and second engaging portions removably secured by the mount in general proximity to the first or second engaging portion selectively secured by the mount.

18. The clamp forming apparatus of claim 17, wherein selectively axially positioning the closure member applies the tangential load around the circumference of the clamp wherein the tangential load applied around the circumference of the clamp is a pre-load of approximately 800 lbs, which thereby leaves a residual load of approximately 400-600 lbs.

19. The clamp forming apparatus of claim 17, wherein the pair of piercing arms is mechanically linked and travel at an approximately similar speed and distance during the engaging operation.

20. The clamp forming apparatus of claim 15, wherein the securing member pierces the engaging portions in a direction normal to the closure load reduces spring back of the clamp after being formed.

21. The manual clamp forming apparatus of claim 15, wherein the securing member secures the engaging portions of the clamp together in a direction generally parallel to a width of the clamp.

22. A clamp forming apparatus for forming a clamp having first and second engaging portions, the clamp forming apparatus comprising:
a clamp mounting device capable of securing at least one of the first and second portions of the clamp;
a closure assembly adjacent the clamp mounting device;
an actuator operably coupled to the closure assembly, wherein the actuator engages the second portion of the clamp to position the second portion adjacent the first portion causing the clamp to apply a tangential load; and
at least one piercing arm capable of piercing at least one of the first or second portions of the clamp in a direction generally perpendicular to the tangential load applied by the clamp.

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. A clamp forming apparatus for forming a clamp around a device, the clamp forming apparatus comprising:
a closure assembly operable to close the clamp via a tangential load applied around a circumference of the clamp to form the clamp around the device; and
a clamp positioning insert securing the clamp to be formed, wherein the clamp positioning insert is operatively engaged with a load cell.

35. The clamp forming apparatus of claim 34, wherein the clamp provides an approximately 360 degree seal around the device.

36. The clamp forming apparatus of claim 35, wherein the closure assembly includes an actuator, wherein the actuator is capable of selectively positioning the closure assembly to apply the tangential load around the circumference of the clamp.

37. The clamp forming apparatus of claim 35, wherein the clamp positioning insert transfers a load or force from the clamp into the load cell, whereby the load or force used by the closure assembly to close the clamp is measured.

38. The clamp forming apparatus of claim 37 further comprising a computer or processor operatively coupled with the load cell to analyze or monitor the measured load or force used by the closure assembly to close the clamp.

39. A clamp forming apparatus for forming a clamp around a device, the clamp forming apparatus comprising:
a securing assembly having a shaft operable by an actuator;
a guide rod operatively engaged with the shaft;
at least one securing member operatively engaged with the guide rod, such that axial positioning of the guide road operatively positions the at least one securing member to engage the clamp in a direction normal to a circumference of the clamp; and
a load cell operatively coupled with the at least one securing member.

40. The clamp forming apparatus of claim 39, wherein the securing member includes a pair of piercing arms.

41. The clamp forming apparatus of claim 40, wherein the pair of piercing arms is mechanically linked and travel at an approximately similar speed and distance during the engaging operation.

42. The clamp forming apparatus of claim 39, wherein engaging the clamp in a direction normal to the circumference of the clamp reduces spring back of the clamp after being formed.

43. The clamp forming apparatus of claim 39, wherein the load cell monitors at least one of an amount of force applied in engaging the clamp, and the distance portions of the clamp moved during the engaging operation.

44. (canceled)

45. (canceled)

46. (canceled)

47. (canceled)

48. (canceled)

49. (canceled)

50. (canceled)

51. (canceled)
